(19) United States
(12) Patent Application Publication
(10) Pub. No.: US 2025/0202861 A1
(43) Pub. Date: Jun. 19, 2025

(54) INFORMATION PROCESSING METHOD, INFORMATION PROCESSING DEVICE, AND INFORMATION PROCESSING SYSTEM

(71) Applicant: SONY GROUP CORPORATION, TOKYO (JP)

(72) Inventor: HIROAKI TAKANO, TOKYO (JP)

(21) Appl. No.: 18/847,849

(22) PCT Filed: Mar. 17, 2023
(86) PCT No.: PCT/JP2023/010573

§ 371 Date: Sep. 17, 2024

(30) Foreign Application Priority Data
Mar. 25, 2022 (JP) 2022-050762

(51) Int. Cl. H04L 61/2514; H04L 61/5046

(52) U.S. Cl. CPC H04L 61/2514; H04L 61/5046

(57) ABSTRACT

Disclosed is an information processing method executed by an information processing device connected to a first management function of managing inter-private network communication of a plurality of private networks connected to each other by secure communication, the information processing device having at least one of second management functions respectively disposed in the plurality of private networks, in which the second management function manages a plurality of IP address resources each including a plurality of IP addresses; the plurality of IP address resources managed by the second management function include one or a plurality of first IP address resources and one or a plurality of second IP address resources, in which the one or plurality of first IP address resources are used for intra-private network communication, and the one or plurality of second IP address resources are used for the inter-private network communication; and the second management function includes notifying the first management function of information on the one or plurality of second IP address resources, and performing, based on information on the IP address resource allocated from the first management function, setting regarding an IP address for the inter-private network communication.

### FIELD

The present disclosure relates to an information processing method, an information processing device, and an information processing system.

### BACKGROUND

In recent years, a private network using cellular radio communication has attracted attention. A communication device in the private network can communicate not only with other communication devices in the private network but also with communication devices outside the private network (for example, communication devices in another private network).

### CITATION LIST

### Patent Literature

Patent Literature 1: JP 2001-136198 A

### SUMMARY

### Technical Problem

When a plurality of private networks are connected to each other to create a closed network, it is necessary to prevent IP addresses used in the respective private networks from overlapping each other. However, in the IoT era, it is assumed that the number of devices connected to the closed network reaches tens of thousands or millions of devices, and thus it is difficult to prevent the IP addresses from overlapping each other. In Patent Literature 1 described above, since global IP address translation is performed on the private IP address in order to connect a plurality of closed networks, a delay for translation occurs.

Therefore, the present disclosure proposes an information processing method, an information processing device, and an information processing system capable of easily implementing a closed network in which a plurality of private networks are connected to each other.

It is noted that the above-described problem or object is merely one of the plurality of problems or objects that can be solved or achieved by a plurality of embodiments disclosed in the present specification.

### Solution to Problem

In order to solve the above problem, an information processing method according to one embodiment of the present disclosure executed by an information processing device connected to a first management function of managing inter-private network communication of a plurality of private networks connected to each other by secure communication, the information processing device having at least one of second management functions respectively disposed in the plurality of private networks, wherein the second management function manages a plurality of IP address resources each including a plurality of IP addresses, the plurality of IP address resources managed by the second management function include one or a plurality of first IP address resources and one or a plurality of second IP address resources, the one or plurality of first IP address resources being used for intra-private network communication, the one or plurality of second IP address resources being used for the inter-private network communication, and the second management function includes: notifying the first management function of information on the one or plurality of second IP address resources; and performing, based on information on the IP address resource allocated from the first management function, setting regarding an IP address for the inter-private network communication.

### BRIEF DESCRIPTION OF DRAWINGS

FIG. 1 is a diagram illustrating an example of a private network.

FIG. 2 is a diagram illustrating a communication system in a case where there is one 4G/5G private network of the other party.

FIG. 3 is a diagram illustrating a communication system in a case where there are a plurality of 4G/5G private networks of the other parties.

FIG. 4 is a diagram illustrating a state in which private IP addresses are allocated so as not to overlap each other.

FIG. 5 is a diagram illustrating an outline of a solution of the present embodiment.

FIG. 6 is a diagram illustrating an outline of a solution of the present embodiment.

FIG. 7 is a diagram illustrating a configuration example of a communication system 1 according to an embodiment of the present disclosure.

FIG. 8 is a diagram illustrating a configuration example of a management device 10 according to the embodiment of the present disclosure.

FIG. 9 is a diagram illustrating a configuration example of a base station 20 according to the embodiment of the present disclosure.

FIG. 10 is a diagram illustrating a configuration example of a terminal device 30 according to the embodiment of the present disclosure.

FIG. 11 is a diagram illustrating a configuration example of a network management device 40 according to the embodiment of the present disclosure.

FIG. 12 is a diagram illustrating an example of 5G architecture.

FIG. 13 is a diagram illustrating an example of 4G architecture.

FIG. 14 is a diagram illustrating a solution of a first embodiment.

FIG. 15 is a diagram illustrating a state in which respective private networks are connected to each other.

FIG. 16 is a sequence diagram illustrating an example of an IP address pool setting procedure of the first embodiment.

FIG. 17 is a diagram illustrating a solution of a second embodiment.

FIG. 18 is a sequence diagram illustrating an example of an IP address pool setting procedure of the second embodiment.

FIG. 19 is a flowchart illustrating an example of setting processing of an IP address pool and a routing table in the private network.

FIG. 20 is a flowchart illustrating another example of the setting processing of the IP address pool and the routing table in the private network.

FIG. 21 is a sequence diagram illustrating an example of an IP address pool setting procedure of a third embodiment.

FIG. 22 is a flowchart illustrating a routing operation of the third embodiment.

FIG. 23 is a sequence diagram illustrating another example of the IP address pool setting procedure of the third embodiment.

### DESCRIPTION OF EMBODIMENTS

Hereinafter, embodiments of the present disclosure will be described in detail with reference to the drawings. In each of the following embodiments, the same parts are denoted by the same reference numerals, and a redundant description will be omitted.

In addition, in the present specification and the drawings, a plurality of components having substantially the same functional configuration may be distinguished by attaching different numbers after the same reference numeral. For example, a plurality of configurations having substantially the same functional configuration are distinguished as terminal devices 30₁, 30₂, and 30₃ as necessary. However, in a case where it is not particularly necessary to distinguish each of the plurality of components having substantially the same functional configuration, only the same reference numeral is attached thereto. For example, in a case where it is not necessary to particularly distinguish the terminal devices 30₁, 30₂, and 30₃, the devices are simply referred to as a terminal device 30.

One or more embodiments (including examples and modifications) described below can each be implemented independently. On the other hand, at least some of the plurality of embodiments described below may be appropriately combined with at least some of other embodiments to be implemented. The plurality of embodiments may include novel features different from each other. Therefore, the plurality of embodiments can contribute to solving different objects or problems, and can exhibit different effects.

In addition, the present disclosure will be described according to the following item order.
1. Outline
1-1. Local 5G/Private 5G
1-2. Features of private network
1-3. Collaboration of plurality of private networks
1-4. Outline of problems and solutions of present
embodiment
2. Configuration of communication system
2-1. Overall configuration of communication system
2-2. Configuration of management device
2-3. Configuration of base station
2-4. Configuration of terminal device
2-5. Configuration of network management device
3. Network architecture
3-1. Configuration example of network architecture of 5G
3-2. Configuration example of network architecture of 4G
4. First Embodiment
4-1. Problem
4-2. Solution
5. Second Embodiment
5-1. Problem
5-2. Solution
6. Third Embodiment
6-1. Problem
6-2. Solution
7. Modification
8. Conclusion

### 1. Outline

In recent years, private networks such as a local 5G and a private 5G have attracted attention. The private network is also referred to as a non-public network.

### <1-1. Local 5G/Private 5G>

The local 5G and the private 5G are services of cellular communication performed in a limited area such as a factory, an office, a studio, in a hospital, or in a university. By limiting the service provision to a local area, there is an advantage in that a customized cellular service can be provided. It is noted that, in the present embodiment, the private 5G and the local 5G may be referred to as a 4G/5G private network or a 4G/5G virtual private network. It is noted that the private network is not limited to the 4G/5G private network. In the following description, the private network may be referred to as a non-public cellular closed network or simply a closed network.

Security is emphasized in many use cases. For example, in the case of a factory, a technique having high confidentiality such as a production line of the factory is handled. Even in a hospital or the like, personal information regarding privacy of a patient is often handled, and thus, this is a use case with high confidentiality. In a university and an office as well, personal information is often handled, and communication related to the personal information is required to have high confidentiality.

### <1-2. Features of Private Network>

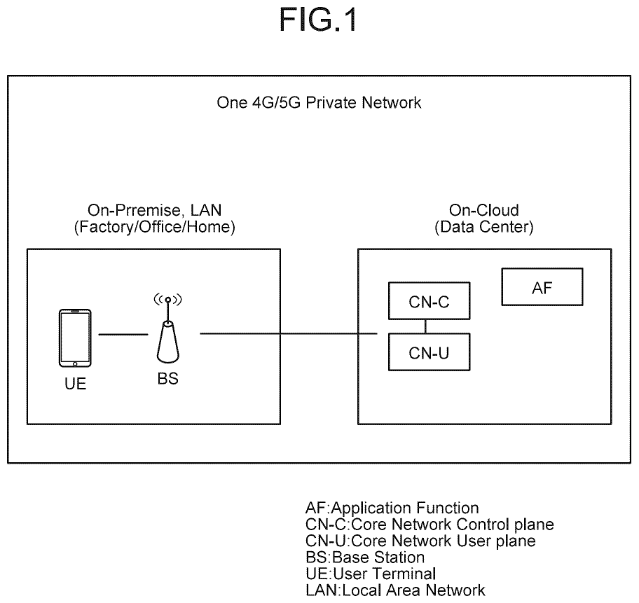

Before describing an outline of the present embodiment, features of the private network will be described. FIG. 1 is a diagram illustrating an example of the private network.

### (1) Properties of Closed Network

In the private network, a LAN and a cloud are connected in the closed network. The closed network is, for example, a virtual private network (VPN). In the closed network, a base station disposed in the LAN and a core network disposed in the cloud are connected to each other using a private IP address without using a public IP address. When communication is performed only in the closed network, it is resistant to eavesdropping from the outside and the like. It is also possible to perform setting to block access from the outside of the closed network at all, or it is also possible to send a packet from the inside to the outside of the closed network and to put only a response into the closed network. In general, it is not possible to access a device or a terminal device in the closed network by applying a trigger from the outside of the closed network, and thus, it can be said that confidentiality of the closed network is high.

Since translation between a private IP address and a global IP address is not required, user datagram protocol (UDP) communication can be easily used. Because a transmission control protocol (TCP) is usually used when translation is required, a feature that the UDP communication is easy to use is attractive for an application using the UDP communication. When the UDP is used, there is an advantage in that a delay is small.

### (2) IP Address Allocated to Terminal Device

When a terminal device is attached to a network, an IP address is allocated from a core network to the terminal device. Usually, a private IP address is allocated. In the case of a public network, a public IP address may be directly allocated to the terminal device, but in a 4G/5G private network which is a non-public network, the private IP address is usually allocated to the terminal device. Therefore, when the terminal device goes out of the closed network, the private IP address is translated into the public IP address by network address translation (NAT) translation.

It is possible to acquire information on the IP address allocated to the terminal device from the core network. In 5G, an application program interface (API) called service based interface (SBI) for acquiring the IP address of the terminal device is prepared. Even in 4G, the IP address of the terminal device can be acquired similarly to 5G by accessing a subscriber file storing the IP address for each terminal device.

In the closed network, by storing the IP address of the terminal device, it is possible to directly transmit an IP packet to the terminal device from an application function (AF) side (that is, network initiated message push).

### <1-3. Collaboration of Plurality of Private Networks>

In the present embodiment, communication between different private networks is considered. For example, a case of connecting a plurality of 4G/5G private networks over the Internet will be considered. In this case, since a packet is once transmitted to a public Internet, security threat increases. It is not desirable in terms of security to directly transmit the IP address of the terminal device to the other party. In addition, when the terminal device goes out of the Internet, the private IP address is translated into the public IP address, which causes a problem related to overload of network address translation (NAT). Therefore, direct communication of UDP is difficult.

It is noted that, in a normal cellular system, when a packet is transmitted to the terminal device by specifying the IP address from the outside of a cellular network, the packet may or may not directly arrive. Although this case is limited to a case in which a telecommunications carrier has a lot of global IP addresses, if the global IP address is directly allocated to the terminal device, it is possible to directly transmit the packet to the global IP address from the outside. However, it can be said that this case depends on a security policy. If the packet can be directly transmitted, there is a risk that undesired traffic flows in from the outside, and therefore such a packet is not allowed in most cases. That is, since the security threat is large, a degree of freedom may be reduced when countermeasure is taken. It is not desirable in terms of security to directly transmit the IP address of the terminal device to the other party. In the case of cellular, there is also a problem that cost of the cellular network is higher than that of the 4G/5G private network. Therefore, it will be important in the future to prepare a plurality of 4G/5G private networks and directly connect the 4G/5G private networks to each other through a VPN tunnel.

Therefore, hereinafter, a case in which different private networks are connected to each other by the VPN tunnel will be considered.

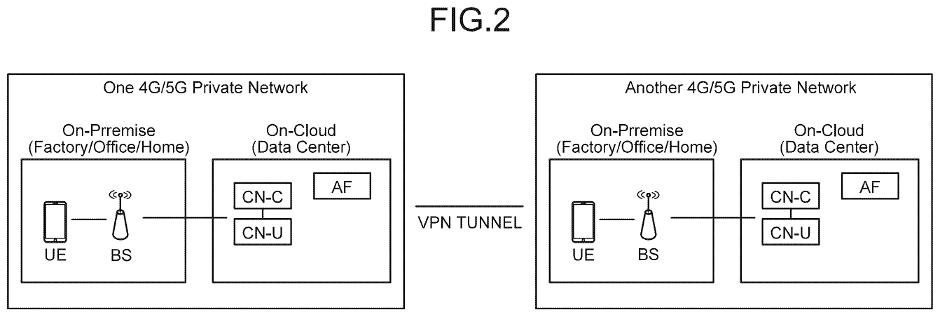

FIG. 2 is a diagram illustrating a communication system in a case where there is one 4G/5G private network of the other party. In the example of FIG. 2, two 4G/5G private networks are directly connected to each other by tunneling of the VPN. Since the closed networks are connected to each other, in the closed networks, a packet can be transmitted to a terminal device or a client application of the other party with a private IP address.

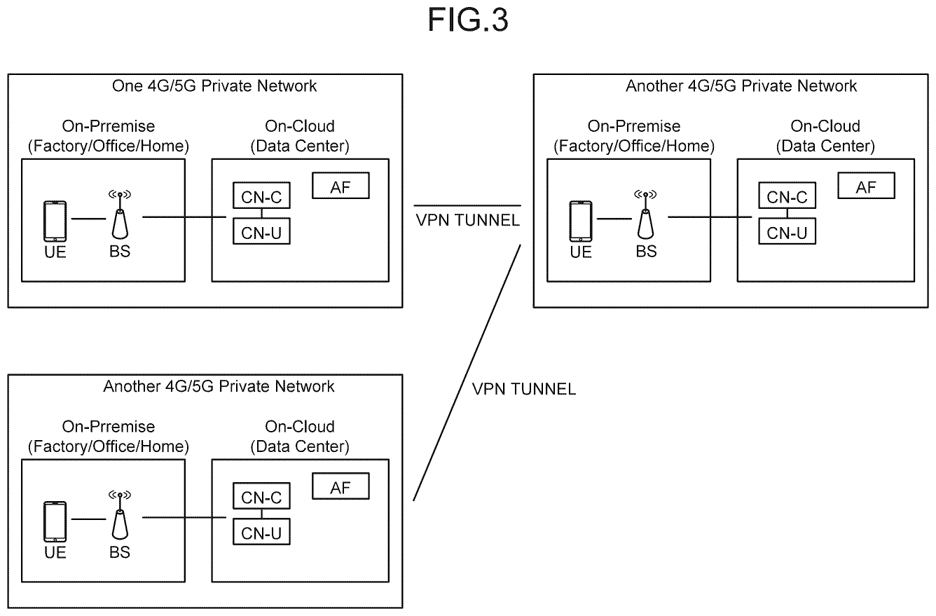

FIG. 3 is a diagram illustrating a communication system in a case where there are a plurality of 4G/5G private networks of the other parties. In a case where there are a plurality of the other parties, as illustrated in FIG. 3, VPN tunnels are set with the plurality of the other parties. Star connection is not desirable because there is a large influence when a failure occurs in the central switch. In the case of the 1:1 pairing, since information is spread only to the other party, this topology is desirable also from the viewpoint of security.

It is noted that a method of connecting a plurality of 4G/5G private networks to each other by secure communication is not limited to a method using the virtual private network (VPN) tunnel. As a method of connecting the plurality of 4G/5G private networks to each other by secure communication, for example, a method of connecting the plurality of 4G/5G private networks by a dedicated line is conceived.

Here, a use case of a network in which the plurality of 4G/5G private networks cooperate is considered. The following is conceived as a use case.

### (1) Internet of Things (IoT)

There is a request to dispose IoT devices under the 4G/5G private network, control the IoT devices by an information processing device, and extract information from the IoT devices. In this case, there is a problem that the scale of an IoT system is insufficient because the number of IoT sensors is limited only by controlling the IoT devices in one 4G/5G private network and acquiring information. Therefore, there is a demand for collecting the pieces of information by causing a plurality of private networks to collaborate with each other. In this case, a location of the IoT device to communicate with is known in advance in many cases. Since TCP connection tends to impose a heavy load of power consumption on the IoT device, there is a demand for communication by UDP.

### (2) Game

When playing a network game, it may be recalled that the other party belongs to a different 4G/5G private network. In this case, since the other party with which communication is desired is the other party determined by a server of a game, it is often not known with which party communication will be performed until last minute. In this case, it is considered that it is often desired to perform communication by UDP rather than TCP due to delay constraints.

### (3) Remote Monitoring

One may wish to monitor a video from a remote camera. In the case of a video such as VR, a large capacity and a low delay may be required. It is desirable from a viewpoint of security that communication can be performed between 4G/5G private networks when a monitoring video is very important information.

### (4) Others

A plurality of private networks may be operated by different business operators. It is desirable that one company perform network management of the plurality of private networks, but customers using the private networks are different from each other. For example, it is assumed that there are a customer A who measures wind power in a first area (for example, Japan) using an IoT sensor capable of measuring wind power, and a customer B who measures wind power in a second area (for example, Europe) using an IoT sensor. Then, it is assumed that a terminal device of the customer A is connected to a private network A, and a terminal device of the customer B is connected to a private network B. At this time, it is assumed that a business operator C needs to collect information from the terminal devices of the customers A and B using a terminal device connected to a private network C. In this case, it is considered that the business operator C wants to connect the private networks A and B.

### <1-4. Outline of Problems and Solutions of Present Embodiment>

Based on the above description, an outline of problems and solutions of the present embodiment will be described.

### <1-4-1. Outline of Problem>

In the present embodiment, a case of constructing a closed network by liking a plurality of private networks is considered. In a case where the number of private networks to be linked is small, it is easy to prevent the IP addresses allocated to the inside of all the linked private networks and the terminal devices from overlapping each other.

However, in an actual operation, it is assumed that the number of private networks is very large (for example, hundreds or thousands of private networks). In this case, in order to prevent the private IP addresses from overlapping each other, a very large number of private IP addresses are required.

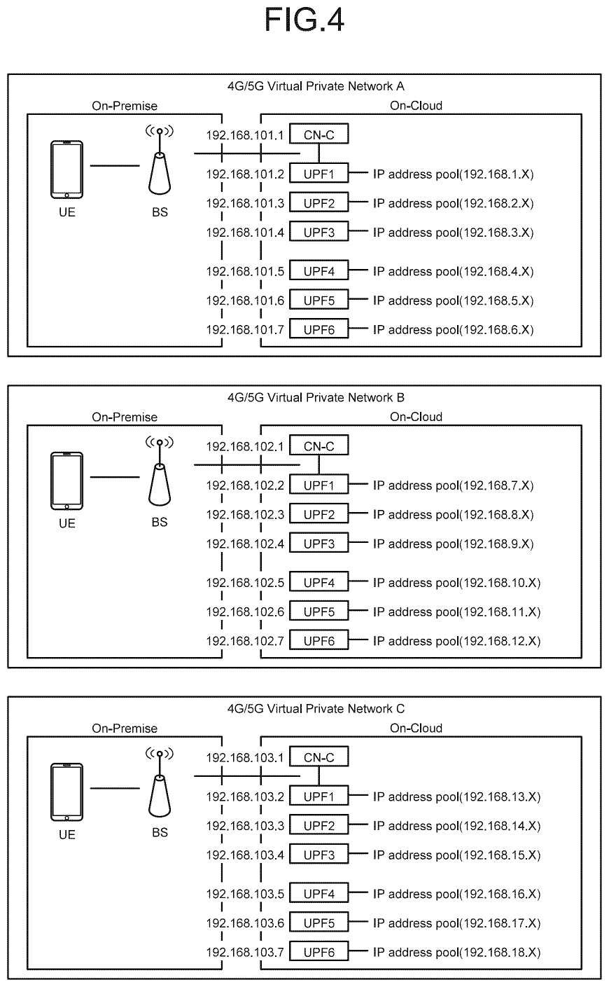

FIG. 4 is a diagram illustrating a state in which private IP addresses are allocated so as not to overlap each other. In the example of FIG. 4, a private network A, a private network B, and a private network C are connected to each other by a VPN tunnel to form one closed network. In each private network, a control plane function (CN-C) and a plurality of user plane functions (UPF 1 to UPF 6) are disposed. In the example of FIG. 4, different IP addresses are respectively allocated to entities (CN-C, UPF 1 to UPF 6). For example, 192.168.101.1 to 192.168.101.7 are allocated to the respective functions of the private network A, 192.168.102.1 to 192.168.102.7 are allocated to the respective functions of the private network B, and 192.168.102.1 to 192.168.102.7 are allocated to the respective functions of the private network C.

In addition, in the example of FIG. 4, different IP address pools are allocated to the respective UPFs in the private network. The IP address pool is a pool of IP addresses used to be allocated to nodes (for example, user equipment (UE) or application function (AF)) in the private network, and includes a plurality of IP addresses. The IP address pool may be referred to as an IP address resource pool or an IP address resource. In the example of FIG. 4, 192.168.1.X to 192.168.6.X are allocated to the respective UPFs of the private network A, 192.168.7.X to 192.168.12.X are allocated to the respective UPFs of the private network B, and 192.168.13.X to 192.168.18.X are allocated to the respective UPFs of the private network C. Here, X is, for example, 0 to 255. For example, IP addresses of 192.168.1.0 to 192.168.1.255 are allocated to the UPF 1 of the private network A.

As described above, when a plurality of private networks are linked, many private IP addresses are required. Therefore, when a plurality of private networks are linked, it is difficult to allocate private IP addresses so as to prevent the IP addresses from overlapping each other. In particular, in a case where the number of private networks to be linked becomes very large, depletion of private IP address resources also becomes a problem. Furthermore, in a case where a plurality of private networks are linked, it is also conceivable that a plurality of administrators of the private networks are provided. In this case as well, it is difficult to allocate the IP addresses so as to prevent the private IP addresses from overlapping each other. This is because it is difficult to perform adjustment among the administrators.

### <1-4-2. Outline of Solution>

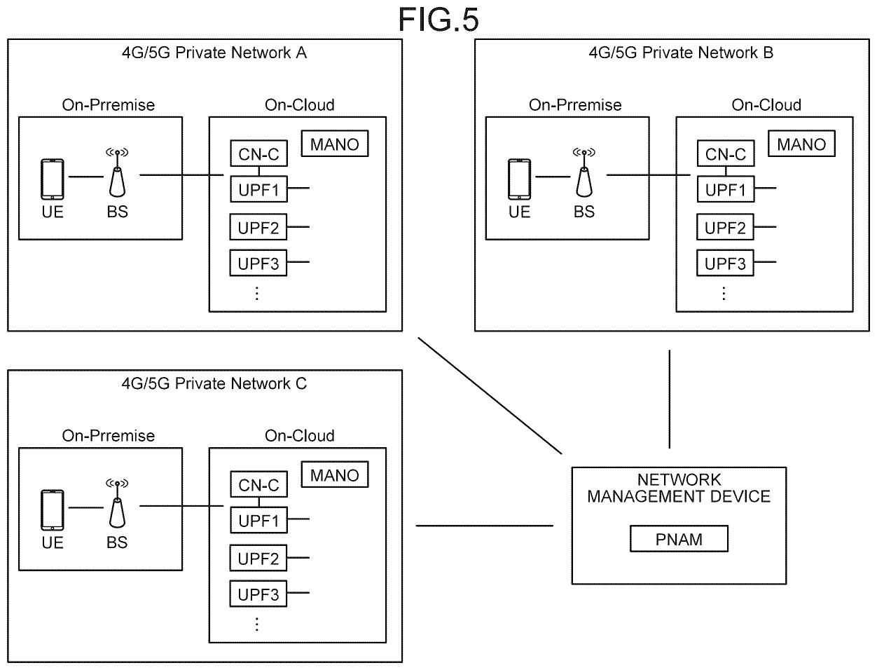

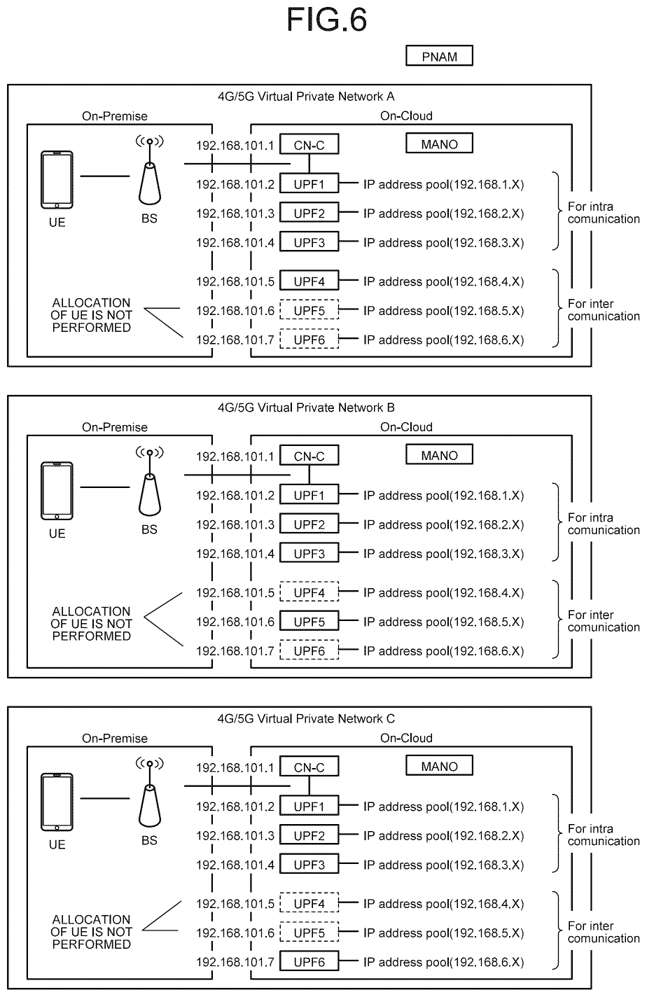

FIGS. 5 and 6 are diagrams each illustrating an outline of a solution of the present embodiment. In the present embodiment, as illustrated in FIG. 5, a network management device connected to a plurality of private networks is disposed on a network (for example, on a public network). The network management device includes a first management function (PNAM: Private Network Association Management) that manages the plurality of private networks. The plurality of private networks are connected to each other by secure communication (for example, VPN tunnel), and a gateway that performs an operation related to an inter-private network communication based on a notification from the PNAM is disposed. Here, the inter-private network communication refers to communication between private networks that perform communication with nodes of other private networks beyond the private network to which a user himself or herself belongs. The PNAM notifies a gateway of at least one private network of the two private networks in which the inter-private network communication is performed of restriction of the inter-private network communication.

In addition, a second management function (MANO: Management And Network Orchestration) is disposed in each of the plurality of private networks. The MANO manages a plurality of IP address pools. As described above, the IP address pool may be referred to as an IP address resource pool or an IP address resource. In the example of FIG. 6, MANOS are disposed in the private networks A to C, respectively. The MANOs of the private networks A to C manage 192.168.1.X to 192.168.6.X, respectively. Here, X is, for example, 0 to 255. The plurality of IP address pools managed by the MANO include one or a plurality of IP address pools for intra-private network communication (first IP address resources), which are used for the intra-private network communication, and one or a plurality of IP address pools for inter-private network communication (second IP address resources), which are used for the inter-private network communication. In the example of FIG. 6, 192.168.1.X to 192.168.3.X are the IP address pools for the intra-private network communication, and 192.168.4.X to 192.168.6.X are the IP address pools for the inter-private network communication.

The MANO notifies the PNAM of information on the IP address pool for the inter-private network communication. For example, in the example of FIG. 6, the MANO of each of the private networks A to C notifies the PNAM of information indicating that 192.168.4.X to 192.168.6.X are the IP address pools for the inter-private network communication. The PNAM acquires the information on the IP address pool for the inter-private network communication from the MANO. Then, the PNAM allocates the IP address pool to be used for the inter-private network communication to each MANO based on the acquired information so that the IP address pools do not overlap each other. For example, in the example of FIG. 6, the PNAM allocates 192.168.4.X to the MANO of the private network A, allocates 192.168.5.X to the MANO of the private network B, and allocates 192.168.6.X to the MANO of the private network C.

Then, the MANO performs setting regarding the IP address for the inter-private network communication based on the information on the IP address pool allocated from the PNAM. For example, the MANO of the private network A enables allocation of the UE for the UPF 4 to which 192.168.4.X is allocated. On the other hand, the MANO of the private network A prevents the UE from being allocated to the UPF 5 to which 192.168.5.X is allocated and the UPF 6 to which 192.168.6.X is allocated. In addition, the MANO of the private network B enables allocation of the UE for the UPF 5 to which 192.168.5.X is allocated. On the other hand, the MANO of the private network B prevents the UE from being allocated to the UPF 4 to which 192.168.4.X is allocated and the UPF 6 to which 192.168.6.X is allocated. In addition, the MANO of the private network C enables allocation of the UE for the UPF 6 to which 192.168.6.X is allocated. On the other hand, the MANO of the private network C prevents the UE from being allocated to the UPF 4 to which 192.168.4.X is allocated and the UPF 5 to which 192.168.5.X is allocated.

Accordingly, it is possible to perform the inter-private network communication with a small number of private IP addresses even in a closed network in which many private networks are linked to each other.

### 2. Configuration of Communication System

Although the outline of the present embodiment has been described above, before the present embodiment is described in detail, a configuration of a communication system 1 including the information processing device of the present embodiment will be described. It is noted that a communication system can be rephrased as an information processing system.

### <2-1. Overall Configuration of Communication System>

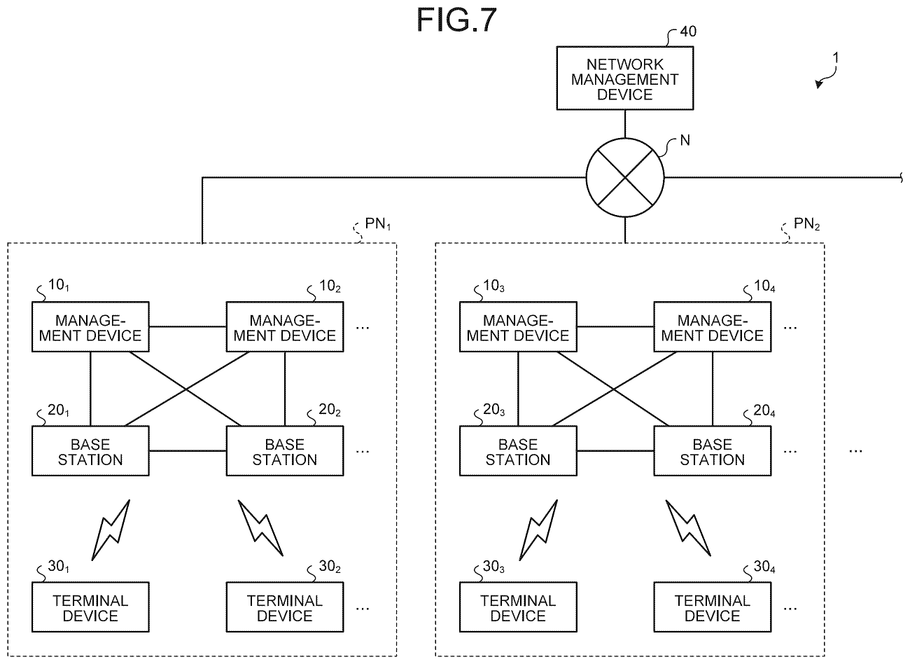

FIG. 7 is a diagram illustrating a configuration example of the communication system 1 according to the embodiment of the present disclosure. The communication system 1 includes a plurality of private networks PN. The private network PN is, for example, a private network using cellular radio communication such as 4G or 5G. The plurality of private networks PN are connected to each other via a network N. It is noted that, although only one network N is illustrated in the example of FIG. 7, a plurality of networks N may exist.

Here, the network N is, for example, a public network such as the Internet. It is noted that the network N is not limited to the Internet, and may be, for example, a local area network (LAN), a wide area network (WAN), a cellular network, a fixed telephone network, or a regional Internet protocol (IP) network. The network N may include a wired network or a radio network.

In each of the plurality of private networks PN, a management device 10, a base station 20, and a terminal device 30 are disposed. In addition, the plurality of private networks PN are connected to a network management device 40 via the network N. The communication system 1 provides a user with a radio network capable of mobile communication by allowing respective radio communication devices constituting the communication system 1 to be operated in association with each other. The radio network of the present embodiment includes, for example, a radio access network and a core network. It is noted that, in the present embodiment, the radio communication device is a device having a function of performing radio communication, and corresponds to the base station 20 and the terminal device 30 in the example of FIG. 7.

The communication system 1 may include a plurality of management devices 10, a plurality of base stations 20, a plurality of terminal devices 30, and a plurality of network management devices 40. In the example of FIG. 7, the communication system 1 includes management devices 10₁ and 10₂ and the like as the management device 10, and includes base stations 20₁ and 20₂ and the like as the base station 20. Furthermore, the communication system 1 includes terminal devices 30₁, 30₂, and 30₃ as the terminal device 30.

It is noted that the devices in the drawings may be considered as devices in a logical sense. That is, a part of the device in the drawing may be implemented by a virtual machine (VM), a container, a docker, or the like, and they may be physically implemented on the same hardware.

It is noted that the communication system 1 may support a radio access technology (RAT) such as long term evolution (LTE) or new radio (NR). LTE and NR are a type of cellular communication technology, and enable mobile communication of a terminal device by arranging a plurality of areas covered by a base station in a cell shape. It is noted that a radio access method used by the communication system 1 is not limited to LTE and NR, and may be another radio access method such as wideband code division multiple access (W-CDMA) or code division multiple access 2000 (cdma2000).

Furthermore, a base station or a relay station constituting the communication system 1 may be a ground station or a non-ground station. The non-ground station may be a satellite station or an aircraft station. If the non-ground station is a satellite station, the communication system 1 may be a Bent-pipe (Transparent) type mobile satellite communication system.

In the present embodiment, the ground station (also referred to as a ground base station) refers to a base station (including a relay station) installed on the ground. Here, the “ground” is a ground in a broad sense including not only land but also on the ground, on the water, and under the water. It is noted that, in the following description, the description of a “ground station” may be replaced with a “gateway”.

It is noted that an LTE base station may be referred to as an evolved node B (eNodeB) or an eNB. Furthermore, the base station of NR is referred to as a gNodeB or a gNB. Additionally, in LTE and NR, a terminal device (also referred to as a mobile station or a terminal) may be referred to as user equipment (UE). It is noted that the terminal device is a type of communication device, and is also referred to as a mobile station or a terminal.

In the present embodiment, the concept of the communication device includes not only a portable mobile device (terminal device) such as a mobile terminal but also a device installed in a structure or a mobile body. A structure or a mobile body itself may be regarded as the communication device. In addition, the concept of the communication device includes not only a terminal device but also a base station and a relay station. The communication device is a type of processing device and information processing device. Furthermore, the communication device can be rephrased as a transmission device or a reception device.

Hereinafter, a configuration of each device constituting the communication system 1 will be specifically described. It is noted that the configuration of each device described below is merely an example. The configuration of each device may be different from the following configuration.

### <2-2. Configuration of Management Device>

Next, a configuration of the management device 10 will be described.

The management device 10 is an information processing device (computer) that manages a radio network. For example, the management device 10 is an information processing device that manages communication of the base station 20. The management device 10 may be, for example, a device having a function as a mobility management entity (MME). The management device 10 may be a device having a function as an access and mobility management function (AMF) and/or a session management function (SMF). Of course, the functions of the management device 10 are not limited to the MME, the AMF, and the SMF. The management device 10 may be a device having a function as a network slice selection function (NSSF), an authentication server function (AUSF), a policy control function (PCF), or a unified data management (UDM). Furthermore, the management device 10 may be a device having a function as a home subscriber server (HSS). In addition, the management device 10 may have the management function (PNAM: Private Network Association Management) provided in the network management device 40 and may function as the network management device 40.

It is noted that the management device 10 may have a function of a gateway. For example, the management device 10 may have a function as a serving gateway (S-GW) or a packet data network gateway (P-GW). In addition, the management device 10 may have a function of a user plane function (UPF). At this time, the management device 10 may have a plurality of UPFs. Furthermore, the management device 10 may have the function of private network association management (PNAM).

The core network includes a plurality of network functions, and each network function may be aggregated into one physical device or distributed to a plurality of physical devices. That is, the management device 10 can be dispersedly disposed in a plurality of devices. Further, this distributed arrangement may be controlled to be performed dynamically. The base station 20 and the management device 10 constitute one network, and provide a radio communication service to the terminal device 30. The management device 10 is connected to the Internet, and the terminal device 30 can use, via the base station 20, various services provided via the Internet.

It is noted that the management device 10 is not necessarily a device constituting the core network. For example, it is assumed that the core network is a core network of wideband code division multiple access (W-CDMA) or code division multiple access 2000 (cdma2000). At this time, the management device 10 may be a device that functions as a radio network controller (RNC).

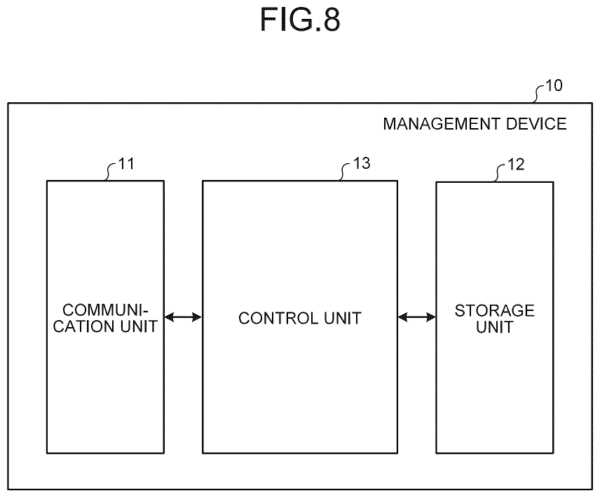

FIG. 8 is a diagram illustrating a configuration example of the management device 10 according to the embodiment of the present disclosure. The management device 10 includes a communication unit 11, a storage unit 12, and a control unit 13. It is noted that the configuration illustrated in FIG. 8 is a functional configuration, and a hardware configuration may be different from the functional configuration. Furthermore, the functions of the management device 10 may be statically or dynamically distributed and implemented in a plurality of physically separated configurations. For example, the management device 10 may include a plurality of server devices.

The communication unit 11 is a communication interface for communicating with other devices. The communication unit 11 may be a network interface or a device connection interface. For example, the communication unit 11 may be a local area network (LAN) interface such as a network interface card (NIC), or may be a universal serial bus (USB) interface including a USB host controller, a USB port, and the like. Furthermore, the communication unit 11 may be a wired interface or a wireless interface. The communication unit 11 functions as a communication means of the management device 10. The communication unit 11 communicates with the base station 20 and the like under the control of the control unit 13.

The storage unit 12 is a storage device capable of reading and writing data, such as a dynamic random access memory (DRAM), a static random access memory (SRAM), a flash memory, or a hard disk. The storage unit 12 functions as a storage means of the management device 10. The storage unit 12 stores, for example, a connection state of the terminal device 30. For example, the storage unit 12 stores a radio resource control (RRC) state or an EPS connection management (ECM) state or a 5G system connection management (CM) state of the terminal device 30. The storage unit 12 may function as a home memory that stores the position information of the terminal device 30.

The control unit 13 is a controller that controls each unit of the management device 10. The control unit 13 is implemented by, for example, a processor such as a central processing unit (CPU), a micro processing unit (MPU), or a graphics processing unit (GPU). For example, the control unit 13 is implemented by allowing the processor to execute various programs stored in a storage device in the management device 10 using the random access memory (RAM) or the like as a work area. It is noted that the control unit 13 may be implemented by, for example, an integrated circuit such as an application specific integrated circuit (ASIC) or a field programmable gate array (FPGA). Any of the CPU, the MPU, the GPU, the ASIC, and the FPGA can be regarded as a controller.

### <2-3. Configuration of Base Station>

Next, a configuration of the base station 20 will be described.

The base station 20 is a radio communication device that performs radio communication with the terminal device 30. The base station 20 may be configured to perform radio communication with the terminal device 30 via a relay station, or may be configured to directly perform radio communication with the terminal device 30.

The base station 20 is a type of communication device. More specifically, the base station 20 is a device corresponding to a radio base station (base Station, node B, eNB, gNB, or the like) or a wireless access point. The base station 20 may be a wireless relay station. Furthermore, the base station 20 may be an optical extension device called a remote radio head (RRH) or a radio unit (RU). Furthermore, the base station 20 may be a receiving station such as a field pickup unit (FPU).

Furthermore, the base station 20 may be an integrated access and backhaul (IAB) donor node or an IAB relay node that provides a radio access line and a radio backhaul line by time division multiplexing, frequency division multiplexing, or space division multiplexing.

It is noted that the radio access technology used by the base station 20 may be a cellular communication technology or a wireless LAN technology. Of course, the radio access technology used by the base station 20 is not limited thereto, and may be another radio access technology. For example, the radio access technology used by the base station 20 may be a low power wide area (LPWA) communication technology. In addition, the radio communication used by the base station 20 may be radio communication using millimeter waves. In addition, the radio communication used by the base station 20 may be radio communication using radio waves or radio communication (optical radio) using infrared rays or visible light. Furthermore, the base station 20 may be capable of performing non-orthogonal multiple access (NOMA) communication with the terminal device 30. Here, the NOMA communication is communication using a non-orthogonal resource (transmission, reception, or both). It is noted that the base station 20 may be able to perform the NOMA communication with another base station 20.

It is noted that the base stations 20 may be able to communicate with each other via a base station-core network interface (for example, NG interface, S1 interface, and the like). This interface may be either a wired interface or a wireless interface. Furthermore, the base stations may be capable of communicating with each other via an inter-base station interface (for example, an Xn interface, an X2 interface, an S1 interface, an F1 interface, and the like). This interface may be either a wired interface or a wireless interface.

It is noted that the concept of the base station includes not only a donor base station but also a relay base station (also referred to as a relay station). For example, the relay base station may be any one of an RF repeater, a smart repeater, and an intelligent surface. In addition, the concept of the base station includes not only a structure having a function of the base station but also a device installed in the structure.

The structure is, for example, a building such as a high-rise building, a house, a steel tower, a station facility, an airport facility, a harbor facility, an office building, a school building, a hospital, a factory, a commercial facility, or a stadium. It is noted that the concept of the structure includes not only the building but also a construction (a non-building structure) such as a tunnel, a bridge, a dam, a wall, or an iron pillar, and equipment such as a crane, a gate, or a windmill. In addition, the concept of the structure includes not only a structure on land (on the ground in a narrow sense) or in the ground, but also a structure on water such as a platform or a megafloat, and a structure under water such as marine observation equipment. The base station may be referred to as an information processing device.

The base station 20 may be a donor station or a relay station. Furthermore, the base station 20 may be a fixed station or a mobile station. The mobile station is a radio communication device (for example, a base station) configured to be movable. At this time, the base station 20 may be a device installed in a mobile body or may be a mobile body itself. For example, a relay station having mobility can be regarded as the base station 20 serving as a mobile station. In addition, a device, which is originally a device having mobility and has a function of a base station (at least a part of the function of the base station), such as a vehicle, an unmanned aerial vehicle (UAV) typified by a drone, or a smartphone, also corresponds to the base station 20 as a mobile station.

Here, the mobile body may be a mobile terminal such as a smartphone or a mobile phone. In addition, the mobile body may be a mobile body (for example, a vehicle such as an automobile, a bicycle, a bus, a truck, a motorcycle, a train, or a linear motor car) that moves on land (on the ground in a narrow sense) or a mobile body (for example, a subway) that moves in the ground (for example, in the tunnel). In addition, the mobile body may be a mobile body (for example, a ship such as a passenger ship, a cargo ship, or a hovercraft) that moves over water or a mobile body (for example, a submersible such as a submersible, a submarine, or an unmanned diving machine) that moves under water. It is noted that the mobile body may be a mobile body (for example, an aircraft such as an airplane, an airship, or a drone) that moves in the atmosphere.

Furthermore, the base station 20 may be a ground base station (a ground station) installed on the ground. For example, the base station 20 may be a base station disposed in a structure on the ground, or may be a base station installed in a mobile body moving on the ground. More specifically, the base station 20 may be an antenna installed in a structure such as a building and a signal processing device connected to the antenna. Of course, the base station 20 may be a structure or a mobile body itself. The term “ground” means not only land (on the ground in a narrow sense) but also ground in a broad sense including underground, over water, and under water. It is noted that the base station 20 is not limited to a ground base station. For example, in a case where the communication system 1 is a satellite communication system, the base station 20 may be an aircraft station. From the perspective of a satellite station, an aircraft station located on the earth is a ground station.

It is noted that the base station 20 is not limited to a ground station. The base station 20 may be a non-ground base station (a non-ground station) capable of floating in the air or space. For example, the base station 20 may be an aircraft station or a satellite station.

The satellite station is a satellite station capable of floating outside the atmosphere. The satellite station may be a device mounted on a space mobile body such as an artificial satellite, or may be a space mobile body itself. The space mobile body is a mobile body that moves outside the atmosphere. Examples of the space mobile body include artificial bodies such as an artificial satellite, a spacecraft, a space station, and a probe. It is noted that the satellite serving as the satellite station may be any one of a low earth orbiting (LEO) satellite, a medium earth orbiting (MEO) satellite, a geostationary earth orbiting (GEO) satellite, and a highly elliptical orbiting (HEO) satellite. Of course, the satellite station may be a device mounted on the low earth orbiting satellite, the medium earth orbiting satellite, the geostationary earth orbiting satellite, or the highly elliptical orbiting satellite.

The aircraft station is a radio communication device capable of floating in the atmosphere, such as an aircraft. The aircraft station may be a device mounted on an aircraft or the like, or may be an aircraft itself. It is noted that the concept of the aircraft includes not only a heavy aircraft such as an airplane or a glider but also a light aircraft such as a balloon or an airship. In addition, the concept of the aircraft includes not only the heavy aircraft and the light aircraft but also a rotorcraft such as a helicopter or an autogyro. It is noted that the aircraft station (alternatively, an aircraft on which the aircraft station is mounted) may be an unmanned aerial vehicle such as a drone.

It is noted that the concept of the unmanned aerial vehicle also includes an unmanned aircraft system (UAS) and a tethered UAS. The concept of the unmanned aerial vehicle also includes a lighter than air (LTA) UAS and a heavier than air (HTA) UAS. Other concepts of the unmanned aerial vehicle also include high altitude UAS platforms (HAPs).

The coverage size of the base station 20 may be as large as a macro cell or as small as a picocell. Of course, the coverage size of the base station 20 may be extremely small, like a femtocell. In addition, the base station 20 may have a beamforming capability. In this case, in the base station 20, a cell or a service area may be formed for each beam.

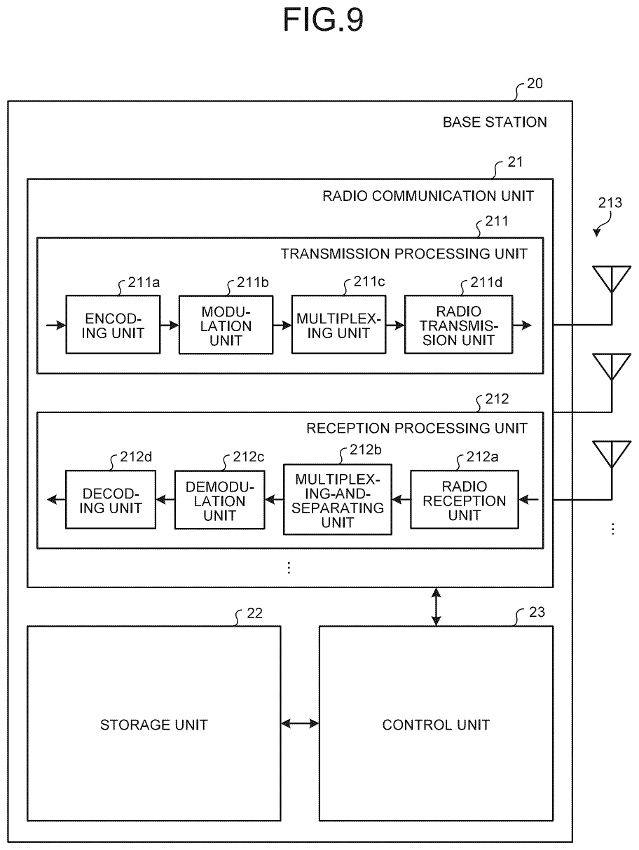

FIG. 9 is a diagram illustrating a configuration example of the base station 20 according to the embodiment of the present disclosure. The base station 20 includes a radio communication unit 21, a storage unit 22, and a control unit 23. It is noted that the configuration illustrated in FIG. 9 is a functional configuration, and a hardware configuration may be different from the functional configuration. Furthermore, the functions of the base station 20 may be implemented in a distributed manner in a plurality of physically separated configurations.

The radio communication unit 21 is a signal processing unit that performs radio communication with other radio communication devices (for example, the terminal device 30). The radio communication unit 21 operates under the control of the control unit 23. The radio communication unit 21 is compatible with one or a plurality of radio access methods. For example, the radio communication unit 21 is compatible with both NR and LTE. The radio communication unit 21 may be compatible with W-CDMA or cdma2000 in addition to NR or LTE. Furthermore, the radio communication unit 21 may support an automatic retransmission technology such as hybrid automatic repeat request (HARQ).

The radio communication unit 21 includes a transmission processing unit 211, a reception processing unit 212, and an antenna 213. The radio communication unit 21 may include a plurality of transmission processing units 211, a plurality of reception processing units 212, and a plurality of antennas 213. It is noted that, when the radio communication unit 21 is compatible with a plurality of radio access methods, each unit of the radio communication unit 21 can be configured individually for each radio access method. For example, the transmission processing unit 211 and the reception processing unit 212 may be individually configured by LTE and NR. Furthermore, the antenna 213 may include a plurality of antenna elements (for example, a plurality of patch antennas). In this case, the radio communication unit 21 may be configured to be able to perform beamforming. The radio communication unit 21 may be configured to be able to perform polarization beamforming using vertically polarized waves (V-polarized waves) and horizontally polarized waves (H-polarized waves).

The transmission processing unit 211 performs processing of transmitting downlink control information and downlink data. For example, the transmission processing unit 211 encodes the downlink control information and the downlink data input from the control unit 23 using an encoding method such as block encoding, convolutional encoding, turbo encoding, or the like. Here, encoding may be performed by polar code or low density parity check code (LDPC code). Then, the transmission processing unit 211 modulates coded bits by a predetermined modulation method such as BPSK, QPSK, 16QAM, 64QAM, or 256QAM. In this case, signal points on a constellation do not necessarily have to be equidistant. The constellation may be a non-uniform constellation (NUC). Then, the transmission processing unit 211 multiplexes a modulation symbol of each channel and a downlink reference signal and disposes the multiplexed symbol in a predetermined resource element. Then, the transmission processing unit 211 performs various types of signal processing on the multiplexed signal. For example, the transmission processing unit 211 performs processing such as conversion into a frequency domain by fast Fourier transformation, addition of a guard interval (cyclic prefix), generation of a baseband digital signal, conversion into an analog signal, quadrature modulation, up-conversion, removal of an extra frequency component, and amplification of power. The signal generated by the transmission processing unit 211 is transmitted from the antenna 213.

The reception processing unit 212 processes the uplink signal received via the antenna 213. For example, the reception processing unit 212 performs, on the uplink signal, down-conversion, removal of an unnecessary frequency component, control of an amplification level, quadrature demodulation, conversion into a digital signal, removal of a guard interval (cyclic prefix), extraction of a frequency domain signal by fast Fourier transformation, and the like. Then, the reception processing unit 212 separates an uplink channel such as a physical uplink shared channel (PUSCH) and a physical uplink control channel (PUCCH) and an uplink reference signal from the signals subjected to these types of processing. Further, the reception processing unit 212 demodulates the received signal using a modulation method such as binary phase shift keying (BPSK) or quadrature phase shift keying (QPSK) with respect to a modulation symbol of the uplink channel. The modulation method used for demodulation may be 16 quadrature amplitude modulation (QAM), 64 QAM, or 256 QAM. In this case, signal points on a constellation do not necessarily have to be equidistant. The constellation may be a non-uniform constellation (NUC). Then, the reception processing unit 212 performs decoding processing on the demodulated encoded bits of the uplink channel. Decoded uplink data and uplink control information are output to the control unit 23.

The antenna 213 is an antenna device (antenna unit) that mutually converts a current and a radio wave. The antenna 213 may include one antenna element (for example, one patch antenna) or may include a plurality of antenna elements (for example, a plurality of patch antennas). In a case where the antenna 213 includes a plurality of antenna elements, the radio communication unit 21 may be configured to be able to perform beamforming. For example, the radio communication unit 21 may be configured to generate a directional beam by controlling directivity of a radio signal using a plurality of antenna elements. It is noted that the antenna 213 may be a dual-polarized antenna. When the antenna 213 is the dual-polarized antenna, the radio communication unit 21 may use vertically polarized waves (V-polarized waves) and horizontally polarized waves (H-polarized waves) in transmitting radio signals. Then, the radio communication unit 21 may control the directivity of the radio signal transmitted using the vertically polarized wave and the horizontally polarized wave. Furthermore, the radio communication unit 21 may transmit and receive spatially multiplexed signals via a plurality of layers including a plurality of antenna elements.

The storage unit 22 is a storage device capable of reading and writing data, such as a DRAM, an SRAM, a flash memory, or a hard disk. The storage unit 22 functions as a storage means of the base station 20.

The control unit 23 is a controller that controls each unit of the base station 20. The control unit 23 is implemented by, for example, a processor such as a central processing unit (CPU) or a micro processing unit (MPU). For example, the control unit 23 is implemented by allowing the processor to execute various programs stored in a storage device in the base station 20 using the random access memory (RAM) or the like as a work area. It is noted that the control unit 23 may be implemented by an integrated circuit such as an application specific integrated circuit (ASIC) or a field programmable gate array (FPGA). Any of the CPU, the MPU, the ASIC, and the FPGA can be regarded as a controller. Furthermore, the control unit 23 may be implemented by a graphics processing unit (GPU) in addition to or instead of the CPU.

In some embodiments, the concept of the base station may consist of a collection of a plurality of physical or logical devices. For example, in the present embodiment, the base station may be distinguished into a plurality of devices such as a baseband unit (BBU) and a radio unit (RU). Then, the base station may be interpreted as an assembly of the plurality of devices. In addition, the base station may be either or both of the BBU and the RU. The BBU and the RU may be connected to each other by a predetermined interface (for example, enhanced common public radio interface (eCPRI)). It is noted that the RU may be rephrased as a remote radio unit (RRU) or a radio dot (RD). Furthermore, the RU may correspond to a gNB distributed unit (gNB-DU) to be described later. Further, the BBU may correspond to a gNB central unit (gNB-CU) to be described below. Alternatively, the RU may be a radio device connected to a gNB-DU to be described later. The gNB-CU, the gNB-DU, and the RU connected to the gNB-DU may be configured to conform to an open radio access network (O-RAN). Further, the RU may be a device formed to be integrated with an antenna. An antenna (for example, an antenna formed to be integrated with the RU) included in the base station may adopt an advanced antenna system and support MIMO (for example, FD-MIMO) or beamforming. Furthermore, the antenna included in the base station may include, for example, 64 transmission antenna ports and 64 reception antenna ports.

In addition, the antenna mounted on the RU may be an antenna panel including one or more antenna elements, and the RU may be mounted with one or more antenna panels. For example, the RU may be mounted with two antenna panels of a horizontally polarized antenna panel and a vertically polarized antenna panel, or two antenna panels of a clockwise circularly polarized antenna panel and a counterclockwise circularly polarized antenna panel. In addition, the RU may form and control an independent beam for each antenna panel.

It is noted that a plurality of base stations may be connected to each other. The one or more base stations may be included in a radio access network (RAN). In this case, the base station may be simply referred to as a RAN, a RAN node, an access network (AN), or an AN node. It is noted that the RAN in LTE is referred to as an enhanced universal terrestrial RAN (EUTRAN). In addition, the RAN in the NR may be referred to as NGRAN. In addition, the RAN in W-CDMA (UMTS) may be referred to as UTRAN.

It is noted that an LTE base station may be referred to as an evolved node B (eNodeB) or an eNB. In this case, the EUTRAN includes one or a plurality of eNodeBs (eNBs). Furthermore, the base station of NR is referred to as a gNodeB or a gNB. In this case, the NGRAN includes one or a plurality of gNBs. The EUTRAN may include a gNB (en-gNB) connected to a core network (EPC) in an LTE communication system (EPS). Similarly, the NGRAN may include an ng-eNB connected to a core network 5GC in a 5G communication system (5GS).

It is noted that, when the base station is the eNB, the gNB, or the like, the base station may be referred to as 3GPP access. In addition, when the base station is a wireless access point, the base station may be referred to as non-3GPP access. Further, the base station may be an optical extension device called a remote radio head (RRH) or a radio unit (RU). Furthermore, in a case where the base station is the gNB, the base station may be a combination of the gNB-CU and the gNB-DU described above, or may be any one of the gNB-CU and the gNB-DU.

Here, the gNB-CU hosts, for communication with the UE, a plurality of upper layers (for example, radio resource control (RRC), service data adaptation protocol (SDAP), and packet data convergence protocol (PDCP)) in an access stratum. On the other hand, the gNB-DU hosts a plurality of lower layers (for example, radio link control (RLC), medium access control (MAC), and physical layer (PHY)) in an access stratum. That is, among messages/pieces of information to be described later, RRC signaling (semi-static notification) may be generated by the gNB-CU, whereas MAC CE and DCI (dynamic notification) may be generated by the gNB-DU. Alternatively, in the RRC configuration (semi-static notification), for example, some configurations such as IE: cellGroupConfig may be generated by the gNB-DU, and the remaining configurations may be generated by the gNB-CU. These configurations may be transmitted and received through the F1 interface to be described later.

It is noted that the base station may be configured to be able to communicate with another base station. For example, when a plurality of base stations are the eNBs or a combination of the eNB and the en-gNB, the base stations may be connected to each other by the X2 interface. Furthermore, when a plurality of base stations are the gNBs or a combination of the gn-eNB and the gNB, the devices may be connected to each other by the Xn interface. Furthermore, when a plurality of base stations are a combination of the gNB-CU and the gNB-DU, the devices may be connected to each other by the above-described F1 interface. A message/information (for example, RRC signaling, MAC control element (MAC CE), or DCI) to be described later may be transmitted between a plurality of base stations, for example, via the X2 interface, the Xn interface, or the F1 interface.

A cell provided by the base station may be referred to as a serving cell. The concept of the serving cell includes a primary cell (PCell) and a secondary cell (SCell). When dual connectivity is configured for the UE (for example, the terminal device 30), the PCell provided by a master node (MN) and zero or one or more SCells may be referred to as a master cell group. Examples of the dual connectivity include EUTRA-EUTRA dual connectivity, EUTRA-NR dual connectivity (ENDC), EUTRA-NR dual connectivity with 5GC, NR-EUTRA dual connectivity (NEDC), and NR-NR dual connectivity.

It is noted that the serving cell may include a primary secondary cell or a primary SCG Cell (PSCell). When the dual connectivity is configured for the UE, the PSCell provided by a secondary node (SN) and zero or one or more SCells may be referred to as a secondary cell group (SCG). Unless specially configured (for example, PUCCH on SCell), a physical uplink control channel (PUCCH) is transmitted in the PCell and the PSCell, but the same is not transmitted in the SCell. In addition, radio link failure is also detected in the PCell and the PSCell, but the radio link failure is not detected in the SCell (may not be detected). As described above, since the PCell and the PSCell have a special role in the serving cell, each of the PCell and the PSCell is also referred to as a special cell (SpCell).

One downlink component carrier and one uplink component carrier may be associated with one cell. In addition, a system bandwidth corresponding to one cell may be divided into a plurality of bandwidth parts (BWPs). In this case, one or a plurality of BWPs may be configured in the UE, and one BWP may be used in the UE as an active BWP. In addition, radio resources (for example, a frequency band, a numerology (subcarrier spacing), and a slot format (slot configuration)) that can be used by the terminal device 30 may be different for each cell, each component carrier, or each BWP.

### <2-4. Configuration of Terminal Device>

Next, a configuration of the terminal device 30 will be described. The terminal device 30 can be rephrased as the user equipment (UE) 30.

The terminal device 30 is a radio communication device that performs radio communication with other communication devices such as the base station 20. The terminal device 30 is, for example, a mobile phone, a smart device (smartphone or tablet), a personal digital assistant (PDA), or a personal computer. Furthermore, the terminal device 30 may be a device such as a business camera provided with a communication function, or may be a motorcycle, a moving relay vehicle, or the like on which a communication device such as a field pickup unit (FPU) is mounted. Furthermore, the terminal device 30 may be a machine to machine (M2M) device or an Internet of things (IoT) device.

It is noted that the terminal device 30 may be able to perform NOMA communication with the base station 20. Furthermore, the terminal device 30 may be able to use an automatic retransmission technology such as HARQ when communicating with the base station 20. Furthermore, the terminal device 30 may be able to perform sidelink communication with another terminal device 30. The terminal device 30 may also be able to use an automatic retransmission technology such as HARQ when performing sidelink communication. It is noted that the terminal device 30 may also be able to perform NOMA communication in communication (sidelink) with another terminal device 30. Furthermore, the terminal device 30 may be able to perform LPWA communication with another communication device (for example, the base station 20 and another terminal device 30). Furthermore, the radio communication used by the terminal device 30 may be radio communication using millimeter waves. It is noted that the radio communication (including the sidelink communication) used by the terminal device 30 may be radio communication using a radio wave or radio communication (optical radio) using infrared rays or visible light.

Furthermore, the terminal device 30 may be a mobile device. The mobile device is a mobile radio communication device. At this time, the terminal device 30 may be a radio communication device installed in a mobile body or may be a mobile body itself. For example, the terminal device 30 may be a vehicle that moves on a road, such as an automobile, a bus, a truck, or a motorcycle, a vehicle that moves on a rail installed on a track, such as a train, or a radio communication device mounted on the vehicle. It is noted that the mobile body may be a mobile terminal, or may be a mobile body that moves on land (on the ground in a narrow sense), in the ground, on water, or under water. Furthermore, the mobile body may be a mobile body that moves inside the atmosphere, such as a drone or a helicopter, or may be a mobile body that moves outside the atmosphere, such as an artificial satellite.

The terminal device 30 may be simultaneously connected to a plurality of base stations or a plurality of cells to perform communication. For example, in a case where one base station supports a communication area via a plurality of cells (for example, pCell and sCell), it is possible to bundle the plurality of cells and perform communication between the base station 20 and the terminal device 30 by a carrier aggregation (CA) technology, a dual connectivity (DC) technology, or a multi-connectivity (MC) technology. Alternatively, the terminal device 30 and the plurality of base stations 20 can communicate with each other by a coordinated multi-point transmission and reception (COMP) technology via cells of different base stations 20.

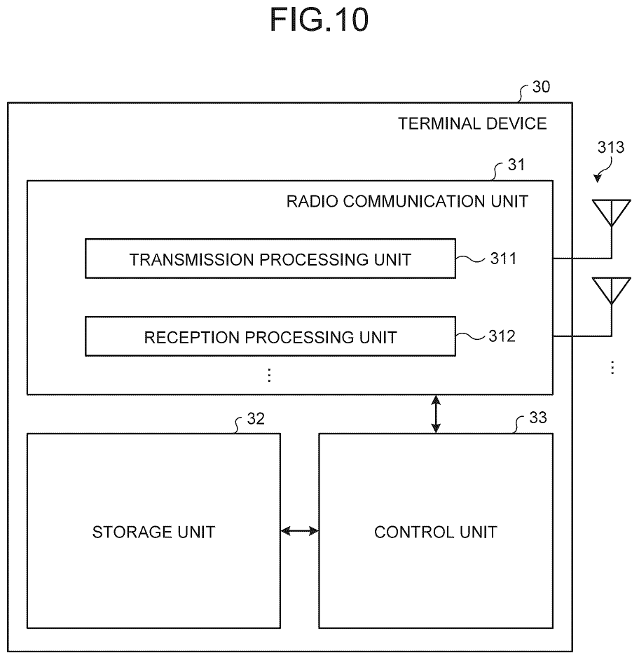

FIG. 10 is a diagram illustrating a configuration example of the terminal device 30 according to the embodiment of the present disclosure. The terminal device 30 includes a radio communication unit 31, a storage unit 32, and a control unit 33. It is noted that the configuration illustrated in FIG. 10 is a functional configuration, and a hardware configuration may be different from the functional configuration. Furthermore, the functions of the terminal device 30 may be implemented in a distributed manner in a plurality of physically separated configurations.

The radio communication unit 31 is a signal processing unit that performs radio communication with other radio communication devices (for example, the base station 20 and another terminal device 30). The radio communication unit 31 operates under the control of the control unit 33. The radio communication unit 31 includes a transmission processing unit 311, a reception processing unit 312, and an antenna 313. The configurations of the radio communication unit 31, the transmission processing unit 311, the reception processing unit 312, and the antenna 313 may be similar to those of the radio communication unit 21, the transmission processing unit 211, the reception processing unit 212, and the antenna 213 of the base station 20. Further, the radio communication unit 31 may be configured to be able to perform beamforming similarly to the radio communication unit 21. Further, similarly to the radio communication unit 21, the radio communication unit 31 may be configured to be able to transmit and receive spatially multiplexed signals.

The storage unit 32 is a storage device capable of reading and writing data, such as a DRAM, an SRAM, a flash memory, or a hard disk. The storage unit 32 functions as a storage means of the terminal device 30.

The control unit 33 is a controller that controls each unit of the terminal device 30. The control unit 33 is implemented by, for example, a processor such as a CPU or an MPU. For example, the control unit 33 is implemented by allowing the processor to execute various programs stored in the storage device in the terminal device 30 using the RAM or the like as a work area. It is noted that the control unit 33 may be implemented by an integrated circuit such as an ASIC or an FPGA. Any of the CPU, the MPU, the ASIC, and the FPGA can be regarded as a controller. Furthermore, the control unit 33 may be implemented by a GPU in addition to or instead of the CPU.

### <2-5. Configuration of Network Management Device>

Next, a configuration of the network management device 40 will be described.

The network management device 40 is an information processing device (computer) having the management function (PNAM: Private Network Association Management) of managing a plurality of private networks. For example, the network management device 40 is a central management server installed by an administrator who manages a private network.

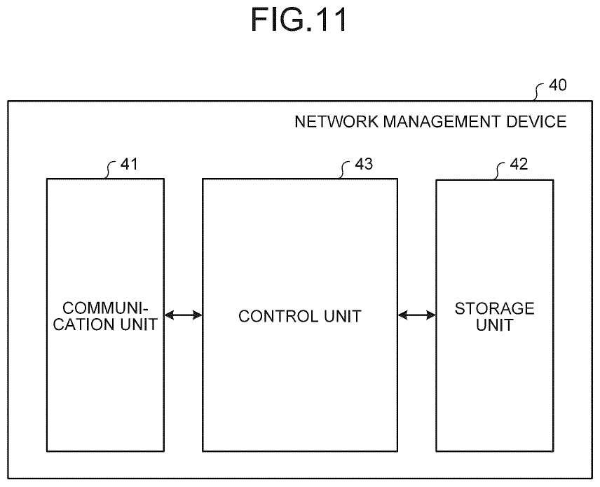

FIG. 11 is a diagram illustrating a configuration example of the network management device 40 according to the embodiment of the present disclosure. The network management device 40 includes a communication unit 41, a storage unit 42, and a control unit 43. It is noted that the configuration illustrated in FIG. 11 is a functional configuration, and a hardware configuration may be different from the functional configuration. Furthermore, the functions of the network management device 40 may be statically or dynamically distributed and implemented in a plurality of physically separated configurations. For example, the network management device 40 may include a plurality of server devices.

The communication unit 41 is a communication interface for communicating with other devices. The communication unit 41 may be a network interface or a device connection interface. For example, the communication unit 41 may be a local area network (LAN) interface such as a network interface card (NIC), or may be a universal serial bus (USB) interface including USB host controller, a USB port, and the like. Furthermore, the communication unit 41 may be a wired interface or a wireless interface. The communication unit 41 functions as a communication means of the network management device 40. The communication unit 41 communicates with the management device 10 and the like under the control of the control unit 43.

The storage unit 42 is a storage device capable of reading and writing data, such as a dynamic random access memory (DRAM), a static random access memory (SRAM), a flash memory, or a hard disk. The storage unit 42 functions as a storage means of the network management device 40.

The control unit 43 is a controller that controls each unit of the network management device 40. The control unit 43 is implemented by, for example, a processor such as a central processing unit (CPU), a micro processing unit (MPU), or a graphics processing unit (GPU). For example, the control unit 43 is implemented by allowing the processor to execute various programs stored in the storage device inside the network management device 40 using the random access memory (RAM) or the like as a work area. It is noted that the control unit 43 may be implemented by an integrated circuit such as an application specific integrated circuit (ASIC) or a field programmable gate array (FPGA). Any of the CPU, the MPU, the GPU, the ASIC, and the FPGA can be regarded as a controller.

### 3. Network Architecture

The configuration of the communication system 1 has been described above. Next, a network architecture applicable to the communication system 1 of the present embodiment will be described.

### <3-1. Configuration Example of Network Architecture of 5G>

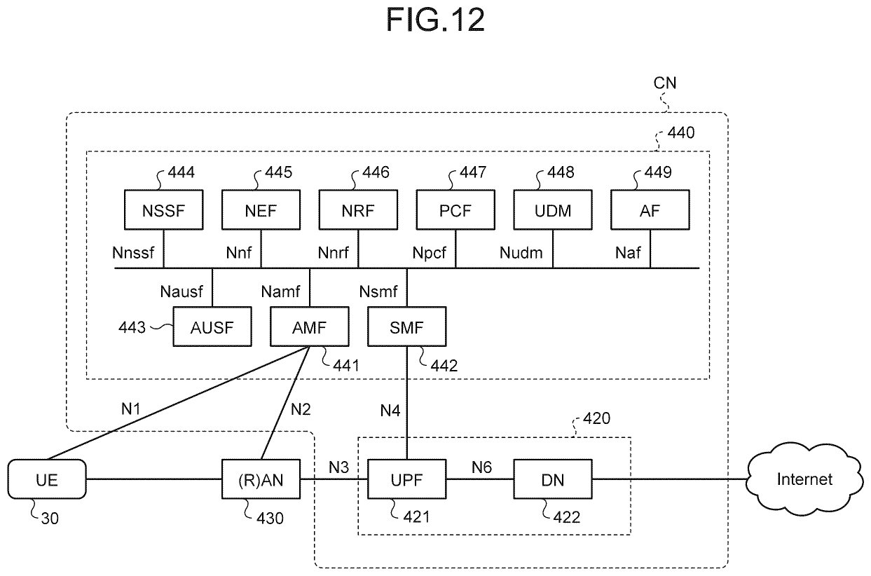

First, an architecture of a fifth generation mobile communication system (5G) will be described as an example of a core network CN of the communication system 1. FIG. 12 is a diagram illustrating an example of the architecture of 5G. The core network CN of 5G is also referred to as 5G core (5GC)/next generation core (NGC). Hereinafter, the core network CN of 5G is also referred to as 5GC/NGC. The core network CN is connected to the user equipment (UE) 30 via an (R)AN 430. The UE 30 is, for example, the terminal device 30.

Although the core network CN illustrated in FIG. 12 does not include the first management function (PNAM: Private Network Association Management), the core network CN may include the PNAM as one of the network functions. Further, the core network CN illustrated in FIG. 12 does not include the second management function (MANO: Management And Network Orchestration), but the core network CN may include the MANO as one of the network functions. Certainly, the PNAM and/or the MANO may be a network function disposed outside the core network CN.

The (R)AN 430 has a function of enabling connection to a radio access network (RAN) and connection to an access network (AN) other than the RAN. The (R)AN 430 includes a base station called a gNB or an ng-eNB.

The core network CN mainly performs connection permission and session management when the UE 30 is connected to the network. The core network CN may include a user plane function group 420 and a control plane function group 440.

The user plane function group 420 includes a user plane function (UPF) 421 and a data network (DN) 422. The UPF 421 has a function of user plane processing. The UPF 421 includes a routing/transmitting function of data handled in a user plane. The DN 422 has, for example, a function of providing connection to an operator's own service such as a mobile network operator (MNO), a function of providing an Internet connection, or a function of providing connection to a third party service. As described above, the user plane function group 420 plays a role of a gateway serving as a boundary between the core network CN and the Internet.

The control plane function group 440 includes an access management function (AMF) 441, a session management function (SMF) 442, an authentication server function (AUSF) 443, a network slice selection function (NSSF) 444, a network exposure function (NEF) 445, a network repository function (NRF) 446, a policy control function (PCF) 447, a unified data management (UDM) 448, and an application function (AF) 449.

The AMF 441 has functions such as registration processing, connection management, and mobility management of the UE 30. The SMF 442 has functions such as session management and IP allocation and management of the UE 30. The AUSF 443 has an authentication function. The NSSF 444 has a function related to selection of a network slice. The NEF 445 has a function of providing network function capabilities and events to a third party, the AF 449, and an edge computing function.

The NRF 446 has a function of finding a network function and holding a profile of the network function. The PCF 447 has a function of policy control. The UDM 448 has functions of generating 3GPP AKA authentication information and processing a user ID. The AF 449 has a function of interacting with the core network and providing a service.

For example, the control plane function group 440 acquires information from the UDM 448 in which subscriber information of the UE 30 is stored, and determines whether to connect the UE 30 to the network. The control plane function group 440 uses contract information of the UE 30 and a key for encryption included in the information acquired from the UDM 448 for such determination. In addition, the control plane function group 440 generates the key for encryption and the like.

That is, the control plane function group 440 determines, for example, whether the network can be connected according to whether information of the UE 30 associated with a subscriber number called an international mobile subscriber identity (IMSI) is stored in the UDM 448. It is toted that the IMSI is stored in, for example, a subscriber identity module (SIM) card in the UE 30.

Here, Namf is a service-based interface provided by the AMF 441, and Nsmf is a service-based interface provided by the SMF 442. In addition, Nnef is a service-based interface provided by the NEF 445, and Npcf is a service-based interface provided by the PCF 447. Nudm is a service-based interface provided by the UDM 448, and Naf is a service-based interface provided by the AF 449. Nnrf is a service-based interface provided by the NRF 446, and Nnssf is a service-based interface provided by the NSSF 444. Nausf is a service-based interface provided by the AUSF 443. Each of these network functions (NFs) exchanges information with another NF via each service-based interface.

In addition, N1 illustrated in FIG. 12 is a reference point between the UE 30 and the AMF 441, and N2 is a reference point between the RAN/AN 430 and the AMF 441. N4 is a reference point between the SMF 442 and the UPF 421, and information is exchanged between these network functions (NFs).

As described above, in the core network CN, an interface for transmitting information and controlling functions via an application programming interface (API) called a service-based interface is prepared.

The API specifies a resource and enables GET (acquisition of resource), POST (generation of resource and addition of data), PUT (generation of resource and update of resource), DELETE (deletion of resource), and the like for the resource. Such a function is generally used, for example, in the technical field related to the Web.

For example, the AMF 441, the SMF 442, and the UDM 448 illustrated in FIG. 12 exchange information with each other using the API in a case of establishing a communication session. Conventionally, it is not assumed that an application (for example, AF 449) uses such an API. However, when the AF 449 uses such an API, the AF 449 can use information of a 5G cellular network, and it is considered that a function of an application can be further evolved.

It is noted that it is difficult for the AF 289 to use the API used by the AMF 441, the SMF 442, and the UDM 448 in the Public Network. However, in the case of a non-public private 5G network, it is considered that the system can be configured including, for example, a change in the API of the core network CN so that the AF 289 can use such an API.

Here, an example of the API will be described. API (1) to API (4) to be described here are described in 3GPP TS23.502.

### API (1)

The API (1) is an API in which the SMF 442 provides notification of information indicating that the UE 30 registered in advance transitions from the power-off state to the power-on state and is attached to the network, and the IP address acquired at that time.

The SMF 442 uses the API (1) to notify the NF of information indicating that the UE 30 of the registered IMSI acquires the IP address.

### API (2)

The UE 30 enters an idle mode when no communication is performed, and transitions to a connected mode when communication is performed. The API (2) is an API in which the AMF 441 provides notification of whether the UE 30 is in the idle mode or the connected mode.

### API (3)

The API (3) is an API for broadcasting a message (paging message) for instructing the UE 30 to transition from the idle mode to the connected mode from the base station.

### API (4)

The API (4) is an API in which the AMF 441 provides position information of the UE 30. The AMF 441 may use the API (4) to inform which tracking area the UE 30 is in, which cell the UE 30 belongs to, and when the UE 30 enters a specific region.

It is noted that an example of the UE 30 in FIG. 12 is the terminal device 30 of the present embodiment. An example of the RAN/AN 430 is the base station 20 of the present embodiment. Furthermore, the management device 10 illustrated in FIG. 7 is an example of a device having a function of, for example, the AF 449 or the AMF 441.

### <3-2. Configuration Example of Network Architecture of 4G>

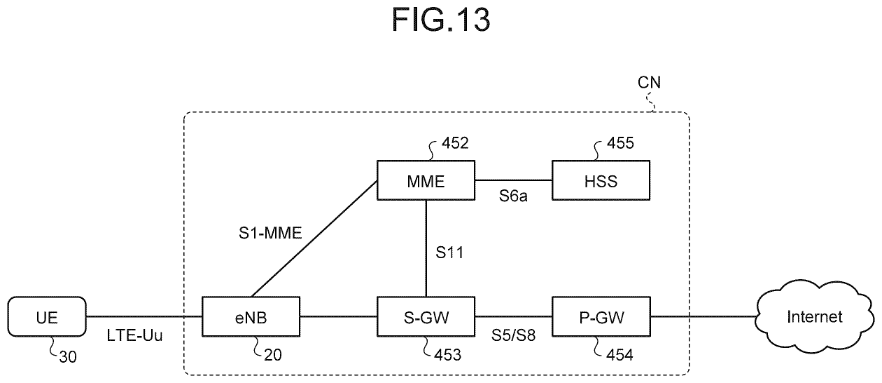

First, an architecture of a fourth generation mobile communication system (4G) will be described as an example of the core network CN of the communication system 1 with reference to FIG. 13. FIG. 13 is a diagram illustrating an example of an architecture of 4G.

Although the core network CN illustrated in FIG. 13 does not include the first management function (PNAM: Private Network Association Management), the core network CN may include the PNAM as one of the network functions. Further, the core network CN illustrated in FIG. 13 does not include the second management function (MANO: Management And Network Orchestration), but the core network CN may include the MANO as one of the network functions. Certainly, the PNAM and/or the MANO may be a network function disposed outside the core network CN.

As illustrated in FIG. 13, the core network CN includes an eNB 20, a mobility management entity (MME) 452, a serving gateway (S-GW) 453, a packet data network gateway (P-GW) 454, and a home subscriber server (HSS) 455.

The eNB 20 functions as a 4G base station. The MME 452 is a control node that handles a signal of a control plane and manages a movement state of a UE 401. The UE 401 transmits an attach request to the MME 452 so as to be attached to a cellular system.

The S-GW 453 is a control node that handles a user plane signal and is a gateway device that switches a transfer path of user data. The P-GW 454 is a control node that handles a user plane signal and is a gateway device serving as a connection point between the core network CN and the Internet. The HSS 455 is a control node that handles subscriber data and performs service control.

The MME 452 corresponds to the functions of the AMF 441 and the SMF 442 in the 5G network. In addition, the HSS 455 corresponds to the function of the UDM 448.

As illustrated in FIG. 13, the eNB 20 is connected to the MME 452 via an S1-MME interface and is connected to the S-GW 453 via an S1-U interface. The S-GW 453 is connected to the MME 452 via an S11 interface, and the MME 452 is connected to the HSS 455 via an S6a interface. The P-GW 454 is connected to the S-GW 453 via an S5/S8 interface.

### 4. First Embodiment

The configuration of the communication system 1 has been described above. Next, an operation of the communication system 1 having such a configuration will be described.

### <4-1. Problem>

### (Reason why a Plurality of Private Networks are Required)

If one private network covers all areas, all areas cannot be used when a failure occurs in a control entity (for example, a control plane of a 4G/5G private network, a 4G MME, or a 5G AMF or SMF). It can be said that a method of covering a small area with an individual private network and being connected to a private network of another area only when necessary is fault-tolerant. In addition, if a wide area is covered at once, security tolerance deteriorates. This is because there is a high possibility that an unsafe UE is included in the wide area. Therefore, in a narrow area, a private network in which only a sufficiently secure UE can participate is constructed, and then the UE is connected to UE of another private network only when necessary. This increases fault tolerance and security tolerance.

### (About NAT)

There is a method of connecting a plurality of private networks by using a network address translator (NAT). This is implemented by translating a private IP address used in the private network into a global IP address by NAT. The global IP address is one IP address in the world. An IP packet having the IP address as a destination IP address is delivered to a private network on the other party via routers in the world. The NAT is also installed in the private network of the other party, and the NAT translates the global IP address into the private IP address of the other party UE and delivers the IP packet to the UE.

This method is communication via the NAT, and communication is not directly performed using the private IP address. Therefore, this method has an increased delay. In this method, when transmitting a packet, a transmission device needs to put the global IP address of the other party in a destination IP address of the IP packet. However, in order for the transmission device to know the global IP address of the other party, it is necessary for a server outside the plurality of private networks to check what the global IP address of each terminal is, and the server to notify the transmission device of the global IP address. This takes time and effort and causes an increase in delay.

That is, this method of using the NAT is effective in a server-client model in which a server is located outside a plurality of private networks. However, in a model in which UE and UE directly communicate with each other, such as a peer to peer (P2P) model, this method using the NAT is not very effective because it is necessary to specially dispose a server (for example, a STURN server in a P2P technology) outside. In services requiring a low delay, it has become important to perform communication in the P2P model instead of the server-client model. Therefore, in recent years, an environment in which all can communicate with the private IP address is required.

### Details of Problem of First Embodiment

In order to connect a plurality of private networks to each other so that the private networks can be used as a closed network (that is, in order to enable a communication device in a closed network to perform communication using a private IP address instead of a public IP address), there must be no private network overlapping the private IP address among the plurality of private networks. This is because, if there are a plurality of the same private IP addresses, the routing behavior of the IP packet becomes unstable, and the IP packet does not reach a correct destination. In order to avoid such a situation, for example, as illustrated in FIG. 4, it is necessary to construct a private network so that the same private IP address does not exist in the private network, and then, to ensure that the same private IP address is not allocated to the UE.

Such a design method functions when a small number of private networks to which a small number of UEs are connected are connected. However, when the number of private networks increases to 100 or 1000, such a design method fails. This is because the required private IP address resources become enormous. In addition, when the number of private networks increases, a problem of depletion of the private IP address resources also occurs. As a countermeasure against depletion of the private IP address resources, a method of using an IP address of IPv6 having a very large address space is also conceivable. However, the number of devices that can use IPv6 is limited, and the number of IP addresses used in the private network is significantly large. Therefore, simply using IPv6 does not solve the problem.

### <4-2. Solution>

In the present embodiment, as illustrated in FIG. 5, the network management device 40 is disposed on a network (for example, on a public network). The network management device 40 includes the first management function (PNAM: Private Network Association Management) that manages the plurality of private networks. The plurality of private networks are connected to each other by secure communication (for example, VPN tunnel), and a gateway that performs an operation related to an inter-private network communication based on a notification from the PNAM is disposed. As described above, the inter-private network communication is communication between private networks that communicate with a node of another private network beyond the private network to which a user himself or herself belongs. The PNAM notifies a gateway of at least one private network of the two private networks in which the inter-private network communication is performed of restriction of the inter-private network communication.

In addition, a second management function (MANO: Management And Network Orchestration) is disposed in each of the plurality of private networks. In the example of FIG. 5, MANOS are disposed in the private networks A to C, respectively. The MANO is directly or indirectly connected to the PNAM. The MANO is disposed, for example, in the management device 10 included in each of the private networks. One information device (for example, the network management device 40) may have a plurality of MANOs that manage each private network.

The MANO manages a plurality of IP address pools. As described above, the IP address pool may be referred to as an IP address resource pool or an IP address resource.

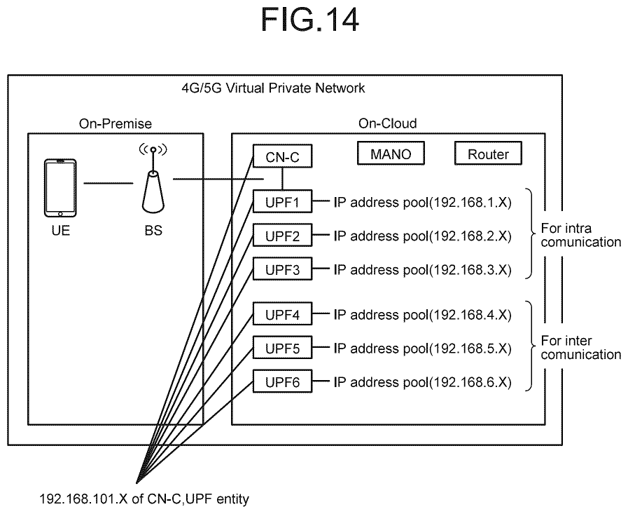

FIG. 14 is a diagram illustrating the solution of the first embodiment. The plurality of IP address resources managed by the MANO include one or a plurality of private IP address resources (a first IP address resource) for intra-private network communication, which is used for the intra-private network communication, and one or a plurality of private IP address resource (a second IP address resource) for inter-private network communication, which is used for the inter-private network communication.

It is noted that, in the following description, the private IP address for the intra-private network communication may be referred to as an intra communication IP address. In the following description, the IP address for the inter-private network communication may be referred to as an inter communication IP address. Further, the private IP address resource (first IP address resource) for the intra-private network communication may be referred to as an intra communication IP address pool. The private IP address resource (second IP address resource) for the intra-private network communication may be referred to as an inter communication IP address pool. The IP address pool can be rephrased as an IP address resource pool or an IP address resource.

The intra communication IP address pool is an IP address group used only inside a single private network, and the inter communication IP address pool is an IP address group used for communication with an external private network.

Since the IP address of the entity of the core network (for example, CN-C or UPF) is used only inside the private network, this is the intra communication IP address.

A core network of the private network (for example, MANO) allocates an IP address to the UE when the terminal device 30 (hereinafter, referred to as UE) is attached to the core network. There are many core networks in which the allocation of the IP address to the UE can be changed for each UPF. Therefore, in the example of FIG. 14, the UE using the UPF 1 is allocated 192.168.1.X from the core network. Here, X means any number from 0 to 255. The UE using the UPF 2 is allocated 192.168.2.X from the core network. In this way, a different IP address pool is allocated to each UPF, and the core network allocates the IP address to the UE from among the IP address pools.

Here, since the UEs belonging to the UPF 1 to the UPF 3 do not communicate with UEs belonging to other private networks by using the private IP addresses, the communication system 1 sets the intra communication IP address pool in the UPF 1 to the UPF 3. Since the UEs belonging to the UPF 4 to the UPF 6 may perform communication with UEs belonging to other private networks by using the private IP addresses, the communication system 1 sets the inter communication IP address pool in the UPF 4 to the UPF 6.

Here, configuring the IP address pool is a management and network orchestration (MANO) function disposed inside each private network. The MANO may be disposed outside a conventional core network, or may be disposed inside the core network as a new function of the core network.

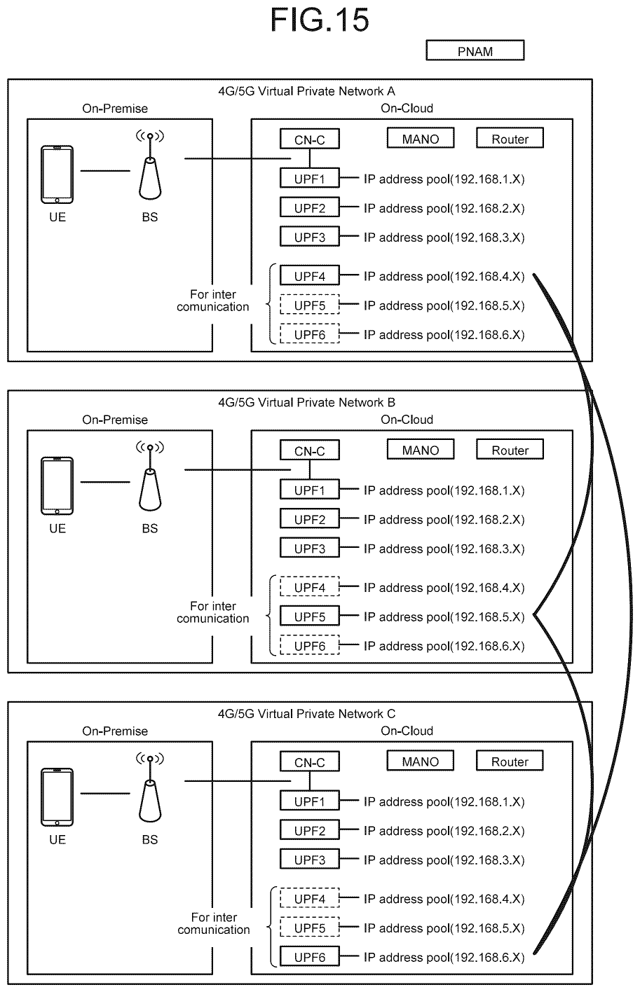

FIG. 15 is a diagram illustrating a state in which respective private networks are connected to each other. Each of the private networks illustrated in FIG. 15 includes a plurality of UPFs (UPF 1 to UPF 6). The intra communication IP address pool is set in each of the UPF 1 to the UPF 3, and the inter communication IP address pool is set in each of the UPF 4 to the UPF 6. These IP address pools are managed by the MANO of each private network.

The intra communication IP address pool and the inter communication IP address pool managed by the MANO are IP address resources selected from the IP address resources shared by the respective private networks. In the example of FIG. 15, a common IP address pool is set for each UPF. That is, in any private network, 192.168.1.X is set in the UPF 1, 192.168.2.X is set in the UPF 2, 192.168.3.X is set in the UPF 3, 192.168.4.X is set in the UPF 4, 192.168.5.X is set in the UPF 5, and 192.168.6.X is set in the UPF 6.

In the example of FIG. 15, it is assumed that the private network A and the private network B are connected to each other by a VPN tunnel. The connection is set in the routing setting of the router of each private network. For example, when a packet, the destination IP address of which is 192.168.5.X comes from the UE in the private network A, the router sends the packet to the private network B.

It is noted that, in the example of FIG. 15, since the same IP address (192.168.5.X) also exists in the private network A which is its own private network, it seems that the packet is not normally transmitted to the UPF 5 of the private network B. However, an administrator (or MANO) of the communication system 1 operates such that only the UPFs 1, 2, 3, and 4 of the private network A are used without allocating the UEs to the UPF 5 and UPF 6 of the private network A. That is, in the example of FIG. 15, in the routing setting of a subnet to which the UPFs for intra communication (UPFs 1, 2, and 3) of the private network A belongs, there is no routing setting to the UPF 5 which is one of the UPFs for inter communication of the private network A, and there is only the routing setting to the UPF 5 which is the UPF for inter communication of the private network B. The administrator (or MANO) of the communication system 1 sets a routing table such that packets to which destination IP addresses for the UEs belonging to the UPFs 1, 2, and 3 for inter communication are allocated are routed to interfaces to the UPFs 1, 2, and 3, respectively.

Here, what is important is that one IP address pool is selected for each private network from the IP address pools (192.168.4.X, 192.168.5.X, and 192.168.6.X) secured for inter communication so as not to overlap each other. In the example of FIG. 15, 192.168.4.X is selected for inter communication in the private network A, 192.168.5.X is selected for inter communication in the private network B, and 192.168.6.X is selected for inter communication in the private network C. The administrator of the communication system 1 prepares the private network association management (PNAM) as a central management server that manages a plurality of private networks. When determination is made to connect the private network A to the private network B, the PNAM determines which IP address pool is used to connect the private network A to the private network B.

In the case of the example of FIG. 15, in the private network A, the UPF 4 (192.168.4.X) is selected from three UPFs for inter communication. In the private network A, the UPF 5 (192.168.5.X) and the UPF 6 (192.168.6.X) are unused. That is, in the private network A, no UE is allocated to the UPF 5 and the UPF 6. In addition, in the case of the example of FIG. 15, in the private network B, the UPF 5 (192.168.5.X) is selected from three UPFs for inter communication. In the private network B, the UPF 4 (192.168.4.X) and the UPF 6 (192.168.6.X) are unused. That is, in the private network B, no UE is allocated to the UPF 4 and the UPF 6. Furthermore, in the case of the example of FIG. 15, in the private network C, the UPF 6 (192.168.6.X) is selected from three UPFs for inter communication. In the private network C, the UPF 4 (192.168.4.X) and the UPF 5 (192.168.5.X) are unused. That is, in the private network C, no UE is allocated to the UPF 4 and the UPF 5.

That is, in a case where there are three IP address pools for inter communication, the private networks A, B, and C select the IP address pools one by one that does not overlap each other. In the example of FIG. 15, since there are three inter communication IP address pools, three private networks can be maximally connected to each other. At this time, the UEs capable of performing the inter-private network communication are only the UEs respectively belonging to the UPF 4 of the private network A, the UPF 5 of the private network B, and the UPF 6 of the private network C.

A router is installed in each private network. The router determines, according to the routing table, whether to transmit a destination of a packet to an internal UPF or to other private networks. The routing table inside the router describes, for each destination IP address, via which interface and to which destination the packet is transmitted. The routing table of the present embodiment describes, for each destination IP address, via which interface the packet is transmitted to the destination UPF. The packet transmitted to the UPF is put into a GTP tunnel and is carried to the UE.

An example of routing setting will be described below. Table 1 is an example of routing setting of the private network A, Table 2 is an example of routing setting of the private network B, and Table 3 is an example of routing setting of the private network C.

TABLE 1
Routing setting of private network A

| Destination IP address | Transmission destination |
|---|---|
| 192.168.1.X | To UPF 1 of private network A |
| 192.168.2.X | To UPF 2 of private network A |
| 192.168.3.X | To UPF 3 of private network A |
| 192.168.4.X | — |
| 192.168.5.X | To UPF 5 of private network B |
| 192.168.6.X | To UPF 6 of private network C |

TABLE 2
Routing setting of private network B

| Destination IP address | Transmission destination |
|---|---|
| 192.168.1.X | To UPF 1 of private network B |
| 192.168.2.X | To UPF 2 of private network B |
| 192.168.3.X | To UPF 3 of private network B |
| 192.168.4.X | To UPF 4 of private network A |
| 192.168.5.X | — |
| 192.168.6.X | To UPF 6 of private network C |

TABLE 3
Routing setting of private network C

| Destination IP address | Transmission destination |
|---|---|
| 192.168.1.X | To UPF 1 of private network C |
| 192.168.2.X | To UPF 2 of private network C |
| 192.168.3.X | To UPF 3 of private network C |
| 192.168.4.X | To UPF 4 of private network A |
| 192.168.5.X | To UPF 5 of private network B |
| 192.168.6.X | — |

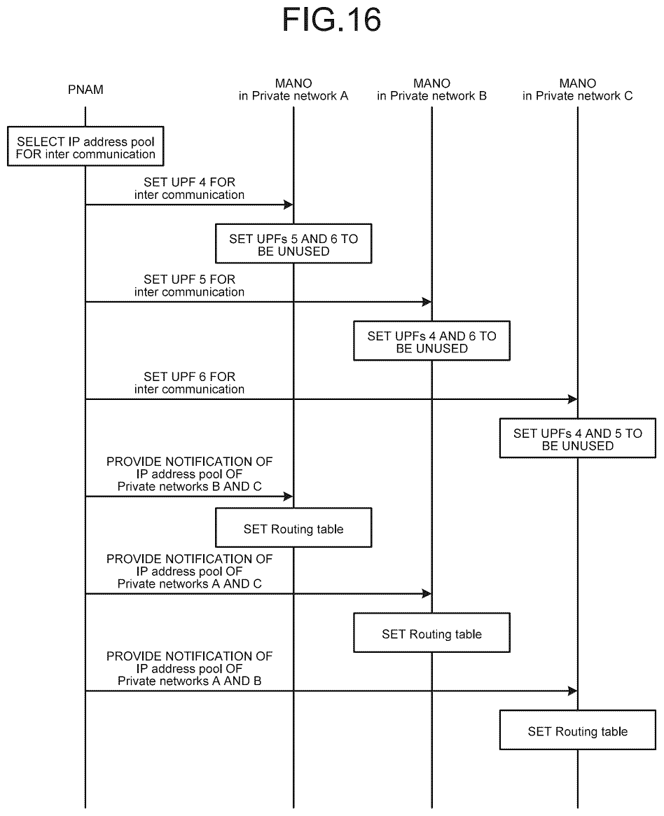

FIG. 16 is a sequence diagram illustrating an example of an IP address pool setting procedure of the first embodiment. It is noted that, in FIG. 16, the private network association management (PNAM) is a management function (first management function) having a function of allocating an IP address pool to each private network so as not to overlap each other. In addition, management and network orchestration (MANO) is a management function (first management function) of performing communication with the PNAM, setting of the IP address pool, setting of the routing table, and the like.

First, the PNAM selects an inter communication IP address pool (UPF for inter communication) to be allocated to each private network so that the IP addresses do not overlap each other. As described above, each private network has a plurality of UPFs (UPF 1 to UPF 6). The intra communication IP address pool is set in each of the UPF 1 to the UPF 3, and the inter communication IP address pool is set in each of the UPF 4 to the UPF 6. In the example of FIG. 16, the PNAM selects the UPF 4 (192.168.4.X) from three UPFs for inter communication in the private network A. In addition, the PNAM selects the UPF 5 (192.168.5.X) from three UPFs for inter communication in the private network B. In addition, the PNAM selects the UPF 6 (192.168.6.X) from three UPFs for inter communication in the private network B. Then, the PNAM notifies the MANO of each private network of information on the selected IP address pool.

The MANO of each private network acquires, from the PNAM, information on the inter communication IP address pool allocated to the private network to which a user himself or herself belongs. Then, the MANO of each private network performs setting related to the inter communication IP address pool. For example, the MANO of the private network A performs setting indicating that the UPF 4 (192.168.4.X) is used for inter communication, and the UPF 5 (192.168.5.X) and the UPF 6 (192.168.6.X) are unused. In addition, the MANO of the private network B performs setting indicating that the UPF 5 (192.168.5.X) is used for inter communication, and the UPF 4 (192.168.4.X) and the UPF 6 (192.168.6.X) are unused. Furthermore, the MANO of the private network C performs setting indicating that the UPF 6 (192.168.6.X) is used for inter communication, and the UPF 4 (192.168.4.X) and the UPF 5 (192.168.5.X) are unused.

In addition, the PNAM notifies the MANO of each private network of information on the inter communication IP address pool allocated to another private network. The MANO of each private network acquires the information on the inter communication IP address pool allocated to another private network. The MANO of each private network sets the routing table based on the acquired information.

It is noted that, in the first embodiment, the number of UPFs (UPFs 1, 2, and 3) for intra communication is three, whereas the number of UPFs (UPFs 4, 5, and 6) for inter communication is three. Therefore, a ratio of the amount of the intra communication IP address to the amount of the inter communication IP address is 1:1. However, the ratio of the amounts of the intra communication IP address to the inter communication IP address may be 7:3 or 2:8. In the present embodiment, the IP address pool is fixedly separated. This is because a design is ready.

In the first embodiment, a way of allocating the IP address pool to each private network is a role of the PNAM. An allocation method is implementation dependent, and various methods are conceivable. For example, the MANO of each private network may request the PNAM to use a self-selected IP address pool, and the PNAM may give an OK to the request. In addition, the PNAM may notify (disclose) the MANO of information for specifying an unallocated IP address pool. The MANO may select one or a plurality of IP address pools selected from the unallocated IP address pools and may request the PNAM to allocate the selected IP address pool.

Further, in the first embodiment, the PNAM equally allocates the inter communication IP address pool to each private network, but the PNAM may unequally allocate the inter communication IP address pool to each private network. For example, the PNAM may allocate the UPFs 4 and 5 to the private network A, and allocate the UPF 6 to the private network B. In this case, when the number of UEs in which the private network A uses the UPF 4 is reduced, traffic quality (throughput quality and delay quality) of the UEs belonging to the UPF 4 is improved.

Further, in the first embodiment, the MANO sets some of the plurality of UPFs for inter communication to be unused. At this time, in a case where there is a UPF that is no longer used among the UPFs for inter communication, the MANO may release the UPF that is no longer used and the inter communication IP address resource allocated to the UPF. For example, in the case of the private network A in FIG. 15, the UPF 5 and 192.168.5.X allocated to the UPF 5 and the UPF 6 and 192.168.6.X allocated to the UPF 6 may be released. Accordingly, effective use of resources is realized.

According to the present embodiment, even if there are 1000 private networks, the communication system 1 can select any number of private networks from among the private networks and connect the selected private networks to each other. In a case where 1000 different private IP addresses are set from the beginning, enormous IP address resources are wasted. On the other hand, in the present embodiment, all the private networks can be constructed with a limited minimum configuration of the same IP address pool. Therefore, complexity at the time of network construction is reduced, and operation is facilitated. Since it is not necessary to wastefully secure a large number of IP address pools, the risk of depletion of private IP addresses used in the closed network is also reduced.

Furthermore, according to the present embodiment, it is possible to construct a closed network of all private IP addresses that do not require NAT translation when a plurality of private networks are connected to each other. In particular, when a peer-to-peer (P2P) application or an application such as VR is used, low-delay communication can be implemented.

### 5. Second Embodiment

Next, an operation of the communication system 1 of a second embodiment will be described.

### <5-1. Problem>

In the first embodiment, a plurality of UPFs for inter communication are disposed in the core network. However, in a case where there is no connection to another private network, computer resources occupied by the UPFs for the inter communication are wasted.

For example, in the example of FIG. 14, the UPF 4, the UPF 5, and the UPF 6 are disposed as the UPFs for inter communication. In a case where one private network is not connected to another private network, the UPF 4, the UPF 5, and the UPF 6 are wasted. If the UPF is not used, the UPF can also be used for intra communication, but this is wasted in the method of the first embodiment.

In the method of the first embodiment, the UPF to which the inter communication IP address pool is fixed is disposed in advance in the core network. Therefore, there is an advantage in that time for arranging the UPF in the core network can be saved. However, for this reason, there are many computer resources that are not used.

### <5-2. Solution>

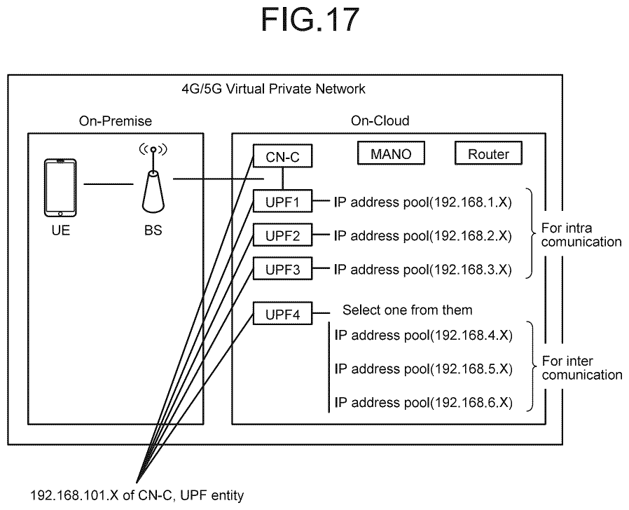

FIG. 17 is a diagram illustrating a solution of the second embodiment. Similarly to the first embodiment, a plurality of IP address resources managed by the MANO include an intra communication IP address pool (first IP address resource) and an inter communication IP address pool (second IP address resource). The intra communication IP address pool and the inter communication IP address pool managed by the MANO are IP address resources selected from the IP address resources shared by the respective private networks, similarly to the first embodiment.

The private network has a plurality of UPFs (UPF 1 to UPF 4). The plurality of UPFs are divided into a UPF for intra communication (first UPF) to which the intra communication IP address pool is allocated and a UPF for inter communication (second UPF) to which an inter communication IP address pool is allocated.

In the second embodiment, the number of UPFs for inter communication included in one private network is smaller than the number of UPFs for intra communication included in the private network. In the second embodiment, the MANO dynamically changes the inter communication IP address pool set in the UPF for inter communication.

In the example of FIG. 17, the number of the UPFs for intra communication included in one private network is three including the UPF 1, the UPF 2, and the UPF 3, and the number of the UPFs for inter communication is one including the UPF 4. The MANO dynamically changes the inter communication IP address pool set in the UPF 4. For example, the MANO sets the IP address pool allocated to the UPF 4 as 192.168.Y.X, and makes a portion of Y variable. For example, MANO selects the portion of Y from 4, 5, and 6. As a result, the number of UPFs for inter communication to be prepared can be reduced from three to one.

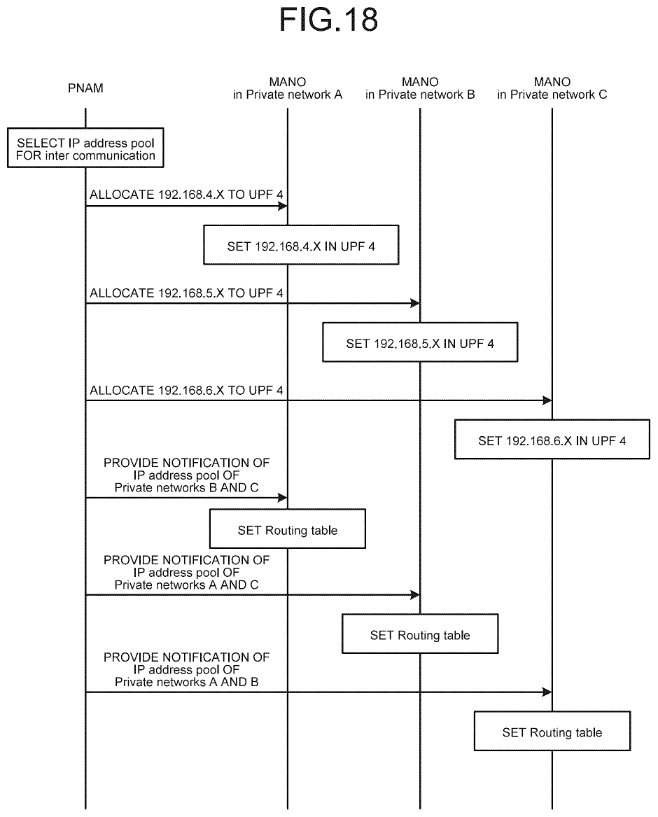

FIG. 18 is a sequence diagram illustrating an example of an IP address pool setting procedure of the second embodiment. It is noted that, in FIG. 18, the private network association management (PNAM) is a management function (first management function) having a function of allocating an IP address pool to each private network so as not to overlap each other. In addition, the management and network orchestration (MANO) is a management function (second management function) of performing communication with the PNAM, setting of the IP address pool, setting of the routing table, and the like.

First, the PNAM selects the IP address pool to be allocated to each private network, so that the IP address pools do not overlap each other. In the example of FIG. 18, the PNAM selects 192.168.4.X from three inter communication IP address pools (192.168.4.X, 192.168.5.X, and 192.168.6.X) in the private network A. Further, the PNAM selects 192.168.5.X from three inter communication IP address pools (192.168.4.X, 192.168.5.X, and 192.168.6.X) in the private network B. Further, the PNAM selects 192.168.6.X from three inter communication IP address pools (192.168.4.X, 192.168.5.X, and 192.168.6.X) in the private network C.

The MANO of each private network acquires information on the inter communication IP address pool allocated to the private network to which a user himself or herself belongs. In each private network, the UPF 4 is disposed as the UPF for inter communication. Then, the MANO of each private network dynamically changes the IP address pool set in the UPF 4 based on the information from the PNAM. For example, the MANO of the private network A sets 192.168.6.X in the UPF 4. In addition, the MANO of the private network B sets 192.168.5.X in the UPF 4. In addition, the MANO of the private network C sets 192.168.4.X in the UPF 4.

In addition, the PNAM notifies the MANO of each private network of information on the inter communication IP address pool allocated to another private network. The MANO of each private network acquires the information on the inter communication IP address pool allocated to another private network. The MANO of each private network sets the routing table based on the acquired information.

According to the present embodiment, since computer resources of the UPF can be reduced, costs associated with the computer resources can be reduced.

### 6. Third Embodiment

Next, an operation of the communication system 1 of a third embodiment will be described.

### <6-1. Problem>

In the first and second embodiments, the inter communication IP address pool is allocated to each private network. However, when there is no connection to another private network, the inter communication IP address pool uselessly occupies the IP address resource.

For example, in the example of FIG. 14, the UPF 4, the UPF 5, and the UPF 6 are disposed as the UPFs for inter communication. In a case where one private network is not connected to another private network, 192.168.4.X, 192.168.5.X, and 192.168.6.X respectively set in the UPF 4, the UPF 5, and the UPF 6 are wasted. If the IP address is not used, it is also possible to use the IP address for intra communication, but this is wasted in the method of the first embodiment. In the method of the second embodiment, the computer resources themselves of the UPF can be reduced, but the inter communication IP address pool itself needs to be secured. In the method of the second embodiment, the inter communication IP address pool cannot be used for another purpose (that is, for intra communication).

In addition, even when inter communication is used in the private network, in many cases, one or a small number of inter communication IP address pools are used in one private network. Many inter communication IP address pools are not used in one private network. Nevertheless, in the methods of the first and second embodiments, the unused inter communication IP address pool cannot be used as the inter communication IP address pool.

This is generalized as a problem that each private network has the same number of inter communication IP address pools.

### <6-2. Solution>

It is assumed that each private network needs to increase the intra communication IP address pool or needs to increase the inter communication IP address pool under individual circumstances.

Therefore, in the third embodiment, a ratio of an IP address pool used as the intra communication IP address pool to an IP address pool used as the inter communication IP address pool is variable. When the ratio is changed inside the private network, the MANO reports information on the inter communication IP address pool to the PNAM. The PNAM uses the reported information on the IP address pool to allocate the inter communication IP address pool to each private network so that the IP address pools do not overlap each other between the private networks.

### <6-2-1. Allocation Pattern 1>

Table 4 is a table illustrating an example of allocation patterns of the intra communication IP address pool and the inter communication IP address pool.

TABLE 4
Allocation pattern 1

| Private | Intra communication | Inter communication |
|---|---|---|
| network | IP address pool | IP address pool |
| A | 192.168.1.X | 192.168.6.X |
| | 192.168.2.X | |
| | 192.168.3.X | |
| | 192.168.4.X | |
| | 192.168.5.X | |
| B | 192.168.1.X | 192.168.4.X |
| | 192.168.2.X | 192.168.5.X |
| | 192.168.3.X | 192.168.6.X |
| C | 192.168.1.X | 192.168.2.X |
| | | 192.168.3.X |
| | | 192.168.4.X |
| | | 192.168.5.X |
| | | 192.168.6.X |

In the case of an allocation pattern 1, in the private network A, a large number of intra communication IP address pools are adopted, and the number of inter communication IP address pools is minimized. In addition, in the private network C, conversely, a large number of inter communication IP address pools are adopted, and the number of intra communication IP address pools is minimized. In addition, the private network B is an intermediate allocation method.

In the case of the allocation pattern 1, the PNAM allocates 192.168.6.X to the private network A as the inter communication IP address pool. Further, the PNAM allocates, for example, 192.168.5.X as the inter communication IP address pool from among three inter communication IP address pools (192.168.4.X, 192.168.5.X, and 192.168.6.X) to the private network B. Further, the PNAM allocates, for example, 192.168.4.X as the inter communication IP address pool from among five inter communication IP address pools (192.168.2.X, 192.168.3.X, 192.168.4.X, 192.168.5.X, and 192.168.6.X) to the private network C.

As a result, the intra communication IP address pool and the inter communication IP address pool can be allocated according to the individual business of each private network.

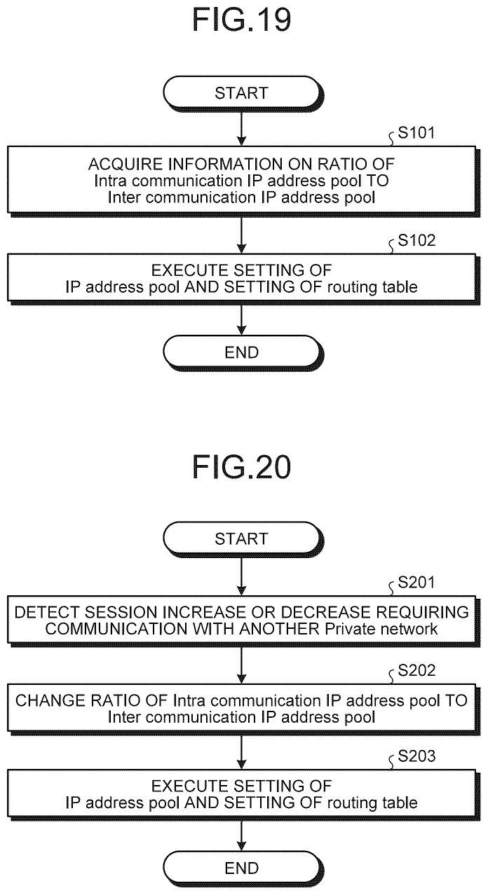

The allocation pattern is statically set by an administrator (or MANO) in advance. FIG. 19 is a flowchart illustrating an example of setting processing of the IP address pool and the routing table in the private network. The setting processing of the IP address pool and the routing table will be described below with reference to the flowchart of FIG. 19.

The MANO acquires information on a ratio of an intra communication IP address pool to an inter communication IP address pool from an administrator considering a method of using the private network (Step S101). The MANO determines allocation of the intra communication IP address pool and the inter communication IP address pool based on the acquired information. Then, the MANO sets the IP address pool and sets the routing table (Step S102). The MANO notifies the PNAM of information on a settable range of an inter communication IP address resource.

It is noted that it is also assumed that there is a private network having few options for the inter communication IP address pool, such as the private network A. In this case, it is considered that there may be a case in which it is difficult to allocate the IP address pool so as to prevent the IP addresses from overlapping each other. In this case, it is also assumed that inter communication cannot be performed. In consideration of this disadvantage, the administrator (or MANO) sets the ratio of the intra communication IP address pool to the inter communication IP address pool in each private network.

It is noted that the MANO can also change this ratio during use of the private network. For example, the MANO may change the ratio of the intra communication IP address pool to the inter communication IP address pool depending on the usage status of the application. FIG. 20 is a flowchart illustrating another example of the setting processing of the IP address pool and the routing table in the private network.

For example, the MANO may change the ratio of the intra communication IP address pool to the inter communication IP address pool when traffic of the inter-private network communication satisfies a predetermined condition. For example, the MANO detects a session increase or decrease that requires connection to another private network (Step S201). It is noted that a function of detecting the session that requires connection to another private network may be, for example, a session management function (SMF).

Then, in a case where the number of sessions requiring connection to another private network increases (for example, when the number of sessions requiring connection to another private network exceeds a predetermined threshold value), the MANO changes the ratio of the intra communication IP address pool to the inter communication IP address pool (Step S202). The ratio may be changed by the administrator. The MANO determines allocation of the intra communication IP address pool and the inter communication IP address pool based on the ratio information. Then, the MANO sets the IP address pool and sets the routing table (Step S203).

It is noted that the MANO may change the ratio of the intra communication IP address pool to the inter communication IP address pool when not the traffic of the inter-private network communication but the traffic of the intra-private network communication satisfies a predetermined condition. Of course, the MANO may change the ratio of the intra communication IP address pool to the inter communication IP address pool based on both the traffic of the inter-private network communication and the traffic of the intra-private network communication.

When the ratio is changed, the MANO notifies the PNAM of information on the changed inter communication IP address resource.

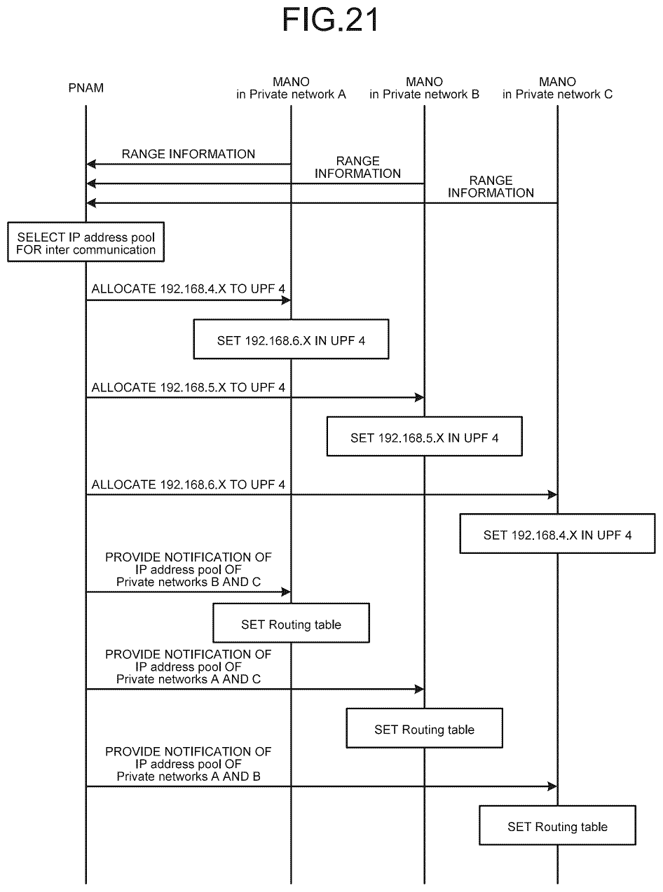

FIG. 21 is a sequence diagram illustrating an example of an IP address pool setting procedure of the third embodiment. It is noted that, in FIG. 21, the private network association management (PNAM) is a management function (first management function) having a function of allocating the IP address pool to each private network so as not to overlap each other. In addition, the management and network orchestration (MANO) is a management function (second management function) of performing communication with the PNAM, setting of the IP address pool, setting of the routing table, and the like.

First, the MANO notifies the PNAM of information on a settable range of an inter communication IP address pool. The PNAM selects the IP address pool to be allocated to each private network, so that the IP address pools do not overlap each other. For example, it is assumed that the PNAM acquires information on the settable range of the inter communication IP address resource, as shown in Table 4, from the MANO. In the example of FIG. 21, the PNAM selects 192.168.6.X in the private network A. Further, the PNAM selects 192.168.5.X from three inter communication IP address pools (192.168.4.X, 192.168.5.X, and 192.168.6.X) in the private network B. Further, the PNAM selects 192.168.4.X from three inter communication IP address pools (192.168.4.X, 192.168.5.X, and 192.168.6.X) in the private network C.

The MANO of each private network acquires information on the inter communication IP address pool allocated to the private network to which a user himself or herself belongs. In each private network, the UPF 4 is disposed as the UPF for inter communication. Then, the MANO of each private network dynamically changes the IP address pool set in the UPF 4 based on the information from the PNAM. For example, the MANO of the private network A sets 192.168.6.X in the UPF 4. In addition, the MANO of the private network B sets 192.168.5.X in the UPF 4. In addition, the MANO of the private network C sets 192.168.4.X in the UPF 4.

In addition, the PNAM notifies the MANO of each private network of information on the inter communication IP address pool allocated to another private network. The MANO of each private network acquires the information on the inter communication IP address pool allocated to another private network. The MANO of each private network sets the routing table based on the acquired information.

Next, an operation of routing in the private network when communication is actually performed will be described.

As an example, it is considered to perform a routing operation in the private network A in Table 4. For example, it is assumed that a node (for example, UE and AF) of the private network A performs inter communication with 192.168.5.X of the private network B. In this case, the private network A also includes 192.168.5.X for intra communication. Therefore, the router cannot distinguish between 192.168.5.X of the private network A and 192.168.5.X of the private network B, and cannot route normally.

Therefore, in the third embodiment, in order to avoid collision between the IP addresses, the MANO sets the routing table so that the router performs routing using information on a transmission source IP address in addition to information on a destination IP address. More specifically, the MANO sets the routing table so that when the transmission source IP address of a packet is included in the inter communication IP address pool, the router transmits the packet to another private network corresponding to the destination IP address.

For example, it is assumed that the transmission source IP address of the packet is 192.168.6.X. As can be seen from Table 4 described above, in the private network A, 192.168.6.X is the IP address for inter communication. Therefore, if the transmission source IP address of the packet is 192.168.6.X, the router transmits the packet to an interface toward the private network B. On the other hand, it is assumed that the transmission source IP address of the packet is 192.168.1.X. As can be seen from Table 4 described above, in the private network A, 192.168.1.X is the IP address for intra communication. Therefore, if the transmission source IP address of the packet is 192.168.1.X, the router transmits the packet to an interface toward the private network A.

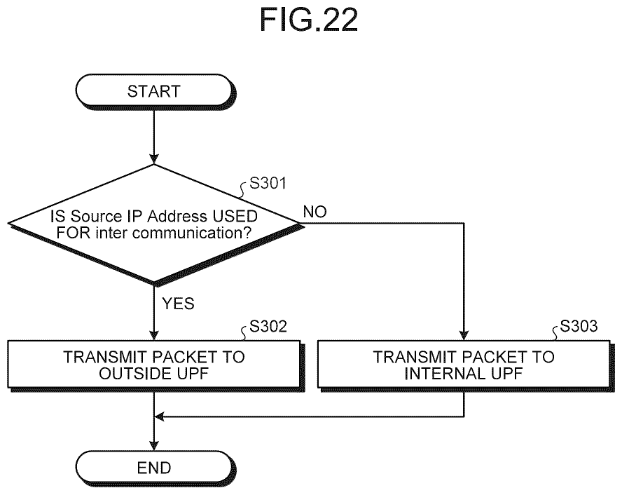

FIG. 22 is a flowchart illustrating a routing operation of the third embodiment. First, the router determines whether the transmission source IP address of the packet is included in the inter communication IP address pool (Step S301). When the transmission source IP address is included in the inter communication IP address pool (Step S301: Yes), the router transmits the packet to the UPF of another private network corresponding to the destination IP address (Step S302). When the transmission source IP address is not included in the inter communication IP address pool (Step S301: No), the router transmits the packet to the internal UPF (Step S303).

### <6-2-2. Allocation Pattern 2>

Table 5 is a table illustrating another example of allocation patterns of the intra communication IP address pool and the inter communication IP address pool.

TABLE 5
Allocation pattern 2

| Private | Intra communication | Inter communication |
|---|---|---|
| network | IP address pool | IP address pool |
| A | 192.168.1.X | 192.168.4.X |
| | 192.168.2.X | |
| | 192.168.3.X | |
| | 192.168.5.X | |
| | 192.168.6.X | |
| B | 192.168.1.X | 192.168.5.X |
| | 192.168.2.X | |
| | 192.168.3.X | |
| | 192.168.4.X | |
| | 192.168.6.X | |
| C | 192.168.1.X | 192.168.6.X |
| | 192.168.2.X | |
| | 192.168.3.X | |
| | 192.168.4.X | |
| | 192.168.5.X | |

In the case of the allocation pattern 2, each private network has a minimum inter communication IP address pool. In addition, the inter communication IP address pools are set so as not to overlap each other. This setting is implemented by allowing the MANO to perform setting in each private network after connection by inter communication is determined. At that time, if there is an unused intra communication IP address pool in each private network, the MANO may preferentially allocate the unused IP address pool.

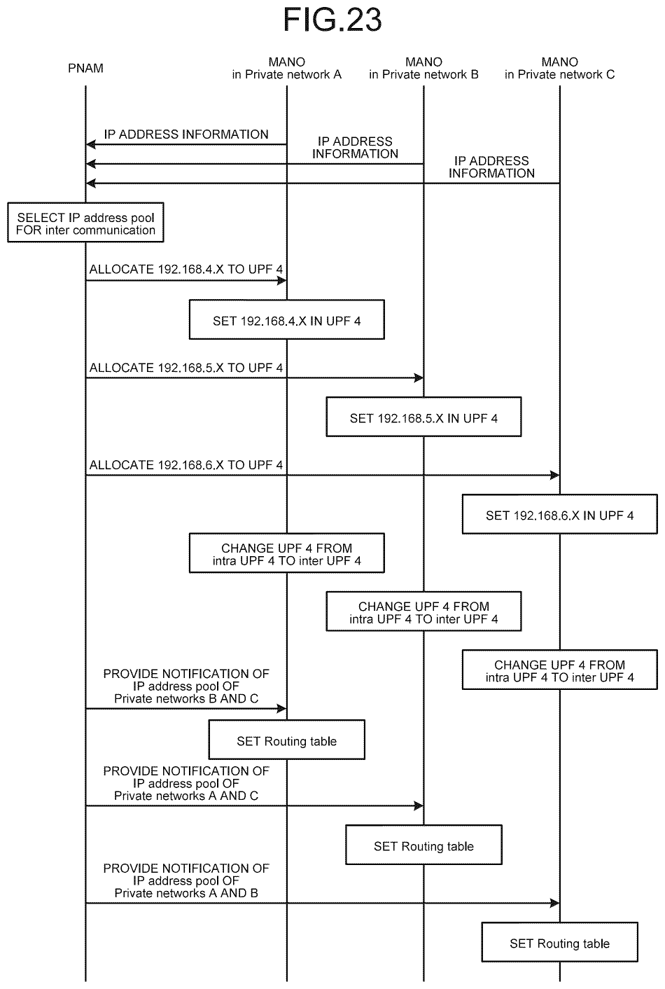

FIG. 23 is a sequence diagram illustrating another example of the IP address pool setting procedure of the third embodiment. It is noted that, in FIG. 23, the private network association management (PNAM) is a management function (first management function) having a function of allocating the IP address pool to each private network so as not to overlap each other. In addition, the management and network orchestration (MANO) is a management function (second management function) of performing communication with the PNAM, setting of the IP address pool, setting of the routing table, and the like.

First, the MANO notifies the PNAM of information on the inter communication IP address pool. The PNAM selects the IP address pool to be allocated to each private network, so that the IP address pools do not overlap each other. In the example of FIG. 23, the PNAM selects 192.168.4.X in the private network A. In addition, the PNAM selects 192.168.5.X in the private network B. Further, the PNAM selects 192.168.6.X in the private network C.

The MANO of each private network acquires information on the inter communication IP address pool allocated to the private network to which a user himself or herself belongs. In each private network, the UPF 4 is disposed as the UPF for inter communication. Then, the MANO of each private network dynamically changes the IP address pool set in the UPF 4 based on the information from the PNAM. For example, the MANO of the private network A sets 192.168.4.X in the UPF 4. In addition, the MANO of the private network B sets 192.168.5.X in the UPF 4. In addition, the MANO of the private network C sets 192.168.6.X in the UPF 4. Then, the MANO of each private network changes the UPF 4 from the UPF for intra communication to the UPF for inter communication.

In addition, the PNAM notifies the MANO of each private network of information on the inter communication IP address pool allocated to another private network. The MANO of each private network acquires the information on the inter communication IP address pool allocated to another private network. The MANO of each private network sets the routing table based on the acquired information.

According to the present embodiment, since the inter communication IP address pool and the intra communication IP address pool can be shared, the IP address resources can be effectively utilized. As a result, since the inter communication IP address pool can be prepared when necessary, it is possible to perform connection to more private networks.

### 7. Modification

The above-described embodiments are examples, and various modifications and applications are possible.

For example, in the above-described embodiments, a plurality of 4G/5G private networks connected by the VPN tunnel is exemplified as “a plurality of private networks (non-public cellular closed network) connected to each other by secure communication”. However, the “plurality of private networks connected to each other by secure communication” is not limited thereto, and may be, for example, “a plurality of 4G/5G private networks configured to perform encrypted communication”. The private network may be a private network other than 4G/5G.

The control device that controls the management device 10, the base station 20, the terminal device 30, and the network management device 40 according to the present embodiment may be implemented by a dedicated computer system or a general-purpose computer system.

For example, a communication program for executing the above-described operation is stored and distributed in a computer-readable recording medium such as an optical disk, a semiconductor memory, a magnetic tape, or a flexible disk. Then, for example, the program is installed in a computer, and the above-described processing is executed to configure the control device. At this time, the control device may be a device (for example, a personal computer) outside the management device 10, the base station 20, and the terminal device 30. Furthermore, the control device may be a device (for example, the control unit 13, the control unit 23, the control unit 33, and the control unit 43) inside the management device 10, the base station 20, the terminal device 30, and the network management device 40.

In addition, the communication program may be stored in a disk device included in a server device on a network such as the Internet so that the communication program can be downloaded to a computer. In addition, the above-described functions may be implemented by cooperation of an operating system (OS) and application software. In this case, a portion other than the OS may be stored in a medium and distributed, or the portion other than the OS may be stored in the server device and downloaded to the computer.

Further, among the pieces of processing described in the above embodiments, all or a part of the processing described as being performed automatically can be manually performed, or all or a part of the processing described as being performed manually can be automatically performed by a known method. In addition, the processing procedure, specific name, and information including various data and parameters illustrated in the document and the drawings can be freely and selectively changed unless otherwise specified. For example, the various types of information illustrated in each drawing are not limited to the illustrated information.

In addition, each component of each device illustrated in the drawings is functionally conceptual, and is not necessarily physically configured as illustrated in the drawings. That is, a specific form of distribution and integration of each device is not limited to the illustrated form, and all or a part thereof can be functionally or physically distributed and integrated in any unit depending on various loads, usage conditions, and the like. It is noted that this configuration by distribution and integration may be performed dynamically.

In addition, the above-described embodiments can be appropriately combined in a region in which the processing contents do not conflict with each other. Furthermore, the order of each step illustrated in the flowchart of the above-described embodiments can be appropriately changed.

Furthermore, for example, the present embodiment can be implemented as any configuration constituting a device or a system, such as a processor serving as a system large scale integration (LSI) or the like, a module using a plurality of processors or the like, a unit using a plurality of modules or the like, a set obtained by further adding other functions to the unit, or the like (that is, a configuration of a part of the device).

It is noted that, in the present embodiment, the system means a set of a plurality of components (devices, modules (parts), and the like), and it does not matter whether all the components are in the same housing. Therefore, a plurality of devices housed in separate housings and connected to each other via a network and one device in which a plurality of modules are housed in one housing are both systems.

Furthermore, for example, the present embodiment can adopt a configuration of cloud computing in which one function is shared and processed by a plurality of devices in cooperation via a network.

### 8. Conclusion

As described above, the communication system 1 according to the present embodiment includes the network management device 40 (first information processing device) including the PANM (first management function) that manages the inter-private network communication of a plurality of private networks connected to each other by secure communication, and the management device 10 (second information processing device) that is connected to the PANM and includes at least one of the MANO (second management function) disposed in each of the plurality of private networks.

The MANO manages each of the plurality of IP address pools. The plurality of IP address pools managed by the MANO include one or a plurality of intra communication IP address pools (first IP address resources) used for the intra-private network communication and one or a plurality of inter communication IP address pools (second IP address resources) used for the inter-private network communication.

The MANO notifies the PANM of information on the one or the plurality of inter communication IP address pools. Then, the PANM acquires the information on the one or the plurality of inter communication IP address pools from the MANO, and allocates the IP address resource used for the inter-private network communication to the MANO based on the acquired information. Then, the MANO performs setting regarding the IP address for the inter-private network communication based on the information on the IP address resource allocated from the PANM.

Accordingly, it is possible to perform the inter-private network communication with a small number of private IP addresses even in a closed network in which many private networks are linked to each other.

Although the embodiments of the present disclosure have been described above, the technical scope of the present disclosure is not limited to the above-described embodiments as it is, and various modifications can be made without departing from the gist of the present disclosure. In addition, components of different embodiments and modifications may be appropriately combined.

Furthermore, the effects of each embodiment described in the present specification are merely examples and are not limited, and other effects may be obtained.

It is noted that the present technology can also have the following configurations.

(1)

An information processing method executed by an information processing device connected to a first management function of managing inter-private network communication of a plurality of private networks connected to each other by secure communication, the information processing device having at least one of second management functions respectively disposed in the plurality of private networks, wherein
the second management function manages a plurality of IP address resources each including a plurality of IP addresses,
the plurality of IP address resources managed by the second management function include one or a plurality of first IP address resources and one or a plurality of second IP address resources, the one or plurality of first IP address resources being used for intra-private network communication, the one or plurality of second IP address resources being used for the inter-private network communication, and
the second management function includes:
notifying the first management function of information on the one or plurality of second IP address resources; and
performing, based on information on the IP address resource allocated from the first management function, setting regarding an IP address for the inter-private network communication.
   (2)

The information processing method according to (1), wherein
the first management function includes a function of allocating the second IP address resource so as not to overlap the plurality of private networks, and
the second management function acquires, from the first management function, information on the second IP address resource allocated to the private network to which a user himself or herself belongs.
   (3)

The information processing method according to (1) or (2), wherein
the first management function includes a function of notifying the second management function of information for specifying unallocated IP address resources, and
the second management function selects one or a plurality of IP address resources selected from among the unallocated IP address resources and requests the first management function to allocate the selected IP address resources.
   (4)

The information processing method according to any one of (1) to (3), wherein
each of the plurality of private networks includes a plurality of user plane functions (UPF), and
the plurality of UPFs include one or a plurality of first UPFs and one or a plurality of second UPFs, each of the first UPFs having the first IP address resource set therein and being used for the intra-private network communication, each of the second UPFs having the second IP address resource set therein and being used for the inter-private network communication.
   (5)

The information processing method according to (4), wherein
the number of the second UPFs provided in the one private network is smaller than the number of the first UPFs provided in the private network, and
the second management function dynamically changes the second IP address resource to be set in the second UPF.
   (6)

The information processing method according to (5), wherein
the number of the second UPFs provided in the one private network is one.
   (7)

The information processing method according to any one of (4) to (6), wherein
the second management function releases, when there is a UPF that is not used among the one or plurality of second UPFs, the UPF that is not used and the second IP address resource set in the UPF.
   (8)

The information processing method according to any one of (1) to (7), wherein
the one or plurality of first IP address resources and the one or plurality of second IP address resources managed by the second management function are IP address resources selected from IP address resources shared by the plurality of private networks.
   (9)

The information processing method according to any one of (1) to (8), wherein
the second management function includes:
changing a ratio of an IP address resource to be used as the first IP address resource to an IP address resource to be used as the second IP address resource at a predetermined timing; and
notifying the first management function of information on the one or plurality of second IP address resources after a change.
   (10)

The information processing method according to (8), wherein
the second management function changes, when traffic of the inter-private network communication satisfies a predetermined condition, a ratio of an IP address resource to be used as the first IP address resource to an IP address resource to be used as the second IP address resource.
   (11)

The information processing method according to (8), wherein
the second management function changes, when traffic of the intra-private network communication satisfies a predetermined condition, a ratio of an IP address resource to be used as the first IP address resource to an IP address resource to be used as the second IP address resource.
   (12)

The information processing method according to any one of (1) to (11), wherein
the second management function sets, when a transmission source IP address of a packet is included in the second IP address resource, a routing table so as to transmit the packet to another private network corresponding to a destination IP address of the packet.
   (13)

An information processing method executed by an information processing device having a first management function of managing inter-private network communication of a plurality of private networks connected to each other by secure communication, wherein
each of the plurality of private networks has a second management function disposed therein, the second management function managing a plurality of IP address resources each including a plurality of IP addresses,
the plurality of IP address resources managed by the second management function include one or a plurality of first IP address resources and one or a plurality of second IP address resources, the one or plurality of first IP address resources being used for intra-private network communication, the one or plurality of second IP address resources being used for the inter-private network communication, and
the first management function includes:
acquiring information on the one or plurality of second IP address resources from the second management function; and
allocating, based on the acquired information, an IP address resource to be used for the inter-private network communication to the second management function.
   (14)

The information processing method according to (13), wherein
the first management function allocates the second IP address resource so as not to overlap the plurality of private networks.
   (15)

The information processing method according to (13) or (14), wherein
the first management function includes a function of notifying the second management function of information for specifying an unallocated IP address resource.
   (16)

An information processing device connected to a first management function of managing inter-private network communication of a plurality of private networks connected to each other by secure communication, the information processing device having at least one of second management functions respectively disposed in the plurality of private networks, wherein
the second management function manages a plurality of IP address resources each including a plurality of IP addresses,
the plurality of IP address resources managed by the second management function include one or a plurality of first IP address resources and one or a plurality of second IP address resources, the one or plurality of first IP address resources being used for intra-private network communication, the one or plurality of second IP address resources being used for the inter-private network communication, and
the second management function includes:
notifying the first management function of information on the one or plurality of second IP address resources; and
performing, based on information on the IP address resource allocated from the first management function, setting regarding an IP address for the inter-private network communication.
   (17)

An information processing device having a first management function of managing inter-private network communication of a plurality of private networks connected to each other by secure communication, wherein
each of the plurality of private networks has a second management function disposed therein, the second management function managing a plurality of IP address resources each including a plurality of IP addresses,
the plurality of IP address resources managed by the second management function include one or a plurality of first IP address resources and one or a plurality of second IP address resources, the one or plurality of first IP address resources being used for intra-private network communication, the one or plurality of second IP address resources being used for the inter-private network communication, and
the first management function includes:
acquiring information on the one or plurality of second IP address resources from the second management function; and
allocating, based on the acquired information, an IP address resource to be used for the inter-private network communication to the second management function.
   (18)

An information processing system comprising a first information processing device and a second information processing device, the first information processing device having a first management function of managing inter-private network communication of a plurality of private networks connected to each other by secure communication, the second information processing device being connected to the first management function and having at least one of second management functions respectively disposed in the plurality of private networks, wherein
the second management function manages a plurality of IP address resources each including a plurality of IP addresses,
the plurality of IP address resources managed by the second management function include one or a plurality of first IP address resources and one or a plurality of second IP address resources, the one or plurality of first IP address resources being used for intra-private network communication, the one or plurality of second IP address resources being used for the inter-private network communication,
the second management function notifies the first management function of information on the one or plurality of second IP address resources,
the first management function acquires the information on the one or plurality of second IP address resources from the second management function and allocates, based on the acquired information, an IP address resource to be used for the inter-private network communication to the second management function, and
the second management function performs, based on information on the IP address resource allocated from the first management function, setting regarding an IP address for the inter-private network communication.

### REFERENCE SIGNS LIST

1 COMMUNICATION SYSTEM
10 MANAGEMENT DEVICE
20 BASE STATION
30 TERMINAL DEVICE
40 NETWORK MANAGEMENT DEVICE
11, 41 COMMUNICATION UNIT
21, 31 RADIO COMMUNICATION UNIT
12, 22, 32, 42 STORAGE UNIT
13, 23, 33, 43 CONTROL UNIT
211, 311 TRANSMISSION PROCESSING UNIT
212, 312 RECEPTION PROCESSING UNIT
213, 313 ANTENNA

1. An information processing method executed by an information processing device connected to a first management function of managing inter-private network communication of a plurality of private networks connected to each other by secure communication, the information processing device having at least one of second management functions respectively disposed in the plurality of private networks, wherein
the second management function manages a plurality of IP address resources each including a plurality of IP addresses,
the plurality of IP address resources managed by the second management function include one or a plurality of first IP address resources and one or a plurality of second IP address resources, the one or plurality of first IP address resources being used for intra-private network communication, the one or plurality of second IP address resources being used for the inter-private network communication, and
the second management function includes:
notifying the first management function of information on the one or plurality of second IP address resources; and
performing, based on information on the IP address resource allocated from the first management function, setting regarding an IP address for the inter-private network communication.

2. The information processing method according to claim 1, wherein
the first management function includes a function of allocating the second IP address resource so as not to overlap the plurality of private networks, and
the second management function acquires, from the first management function, information on the second IP address resource allocated to the private network to which a user himself or herself belongs.

3. The information processing method according to claim 1, wherein
the first management function includes a function of notifying the second management function of information for specifying unallocated IP address resources, and
the second management function selects one or a plurality of IP address resources selected from among the unallocated IP address resources and requests the first management function to allocate the selected IP address resources.

4. The information processing method according to claim 1, wherein
each of the plurality of private networks includes a plurality of user plane functions (UPF), and
the plurality of UPFs include one or a plurality of first UPFs and one or a plurality of second UPFs, each of the first UPFs having the first IP address resource set therein and being used for the intra-private network communication, each of the second UPFs having the second IP address resource set therein and being used for the inter-private network communication.

5. The information processing method according to claim 4, wherein
the number of the second UPFs provided in the one private network is smaller than the number of the first UPFs provided in the private network, and
the second management function dynamically changes the second IP address resource to be set in the second UPF.

6. The information processing method according to claim 5, wherein
the number of the second UPFs provided in the one private network is one.

7. The information processing method according to claim 4, wherein
the second management function releases, when there is a UPF that is not used among the one or plurality of second UPFs, the UPF that is not used and the second IP address resource set in the UPF.

8. The information processing method according to claim 1, wherein
the one or plurality of first IP address resources and the one or plurality of second IP address resources managed by the second management function are IP address resources selected from IP address resources shared by the plurality of private networks.

9. The information processing method according to claim 1, wherein
the second management function includes:
changing a ratio of an IP address resource to be used as the first IP address resource to an IP address resource to be used as the second IP address resource at a predetermined timing; and
notifying the first management function of information on the one or plurality of second IP address resources after a change.

10. The information processing method according to claim 8, wherein
the second management function changes, when traffic of the inter-private network communication satisfies a predetermined condition, a ratio of an IP address resource to be used as the first IP address resource to an IP address resource to be used as the second IP address resource.

11. The information processing method according to claim 8, wherein
the second management function changes, when traffic of the intra-private network communication satisfies a predetermined condition, a ratio of an IP address resource to be used as the first IP address resource to an IP address resource to be used as the second IP address resource.

12. The information processing method according to claim 1, wherein
the second management function sets, when a transmission source IP address of a packet is included in the second IP address resource, a routing table so as to transmit the packet to another private network corresponding to a destination IP address of the packet.

13. An information processing method executed by an information processing device having a first management function of managing inter-private network communication of a plurality of private networks connected to each other by secure communication, wherein
each of the plurality of private networks has a second management function disposed therein, the second management function managing a plurality of IP address resources each including a plurality of IP addresses,
the plurality of IP address resources managed by the second management function include one or a plurality of first IP address resources and one or a plurality of second IP address resources, the one or plurality of first IP address resources being used for intra-private network communication, the one or plurality of second IP address resources being used for the inter-private network communication, and
the first management function includes:
acquiring information on the one or plurality of second IP address resources from the second management function; and
allocating, based on the acquired information, an IP address resource to be used for the inter-private network communication to the second management function.

14. The information processing method according to claim 13, wherein
the first management function allocates the second IP address resource so as not to overlap the plurality of private networks.

15. The information processing method according to claim 13, wherein
the first management function includes a function of notifying the second management function of information for specifying an unallocated IP address resource.

16. An information processing device connected to a first management function of managing inter-private network communication of a plurality of private networks connected to each other by secure communication, the information processing device having at least one of second management functions respectively disposed in the plurality of private networks, wherein
the second management function manages a plurality of IP address resources each including a plurality of IP addresses,
the plurality of IP address resources managed by the second management function include one or a plurality of first IP address resources and one or a plurality of second IP address resources, the one or plurality of first IP address resources being used for intra-private network communication, the one or plurality of second IP address resources being used for the inter-private network communication, and
the second management function includes:
notifying the first management function of information on the one or plurality of second IP address resources; and
performing, based on information on the IP address resource allocated from the first management function, setting regarding an IP address for the inter-private network communication.

17. An information processing device having a first management function of managing inter-private network communication of a plurality of private networks connected to each other by secure communication, wherein
each of the plurality of private networks has a second management function disposed therein, the second management function managing a plurality of IP address resources each including a plurality of IP addresses,
the plurality of IP address resources managed by the second management function include one or a plurality of first IP address resources and one or a plurality of second IP address resources, the one or plurality of first IP address resources being used for intra-private network communication, the one or plurality of second IP address resources being used for the inter-private network communication, and
the first management function includes:
acquiring information on the one or plurality of second IP address resources from the second management function; and
allocating, based on the acquired information, an IP address resource to be used for the inter-private network communication to the second management function.

18. An information processing system comprising a first information processing device and a second information processing device, the first information processing device having a first management function of managing inter-private network communication of a plurality of private networks connected to each other by secure communication, the second information processing device being connected to the first management function and having at least one of second management functions respectively disposed in the plurality of private networks, wherein
the second management function manages a plurality of IP address resources each including a plurality of IP addresses,
the plurality of IP address resources managed by the second management function include one or a plurality of first IP address resources and one or a plurality of second IP address resources, the one or plurality of first IP address resources being used for intra-private network communication, the one or plurality of second IP address resources being used for the inter-private network communication,
the second management function notifies the first management function of information on the one or plurality of second IP address resources,
the first management function acquires the information on the one or plurality of second IP address resources from the second management function and allocates, based on the acquired information, an IP address resource to be used for the inter-private network communication to the second management function, and
the second management function performs, based on information on the IP address resource allocated from the first management function, setting regarding an IP address for the inter-private network communication.
